(19) United States
(12) Patent Application Publication
(10) Pub. No.: US 2023/0351018 A1
(43) Pub. Date: Nov. 2, 2023

(54) METHOD AND SYSTEM TO IDENTIFY FABRICATED ELECTRICAL CIRCUITS WITH HIDDEN HARDWARE MODIFICATIONS

(71) Applicant: GEORGIA TECH RESEARCH CORPORATION, Atlanta, GA (US)

(72) Inventors: Alenka Zajic, Atlanta, GA (US); Milos Prvulovic, Atlanta, GA (US); Baki Berkay Yilmaz, Atlanta, GA (US); Luong Ngoc Nguyen, Atlanta, GA (US)

(21) Appl. No.: 18/027,517

(22) PCT Filed: Sep. 21, 2021
(86) PCT No.: PCT/US2021/051253

§ 371 Date: Mar. 21, 2023

Related U.S. Application Data
(60) Provisional application No. 63/080,906, filed on Sep. 21, 2020.

(51) Int. Cl. G06F 21/56

(52) U.S. Cl. CPC G06F 21/566

(57) ABSTRACT

An exemplary method and system are disclosed that can detect the presence or absence hardware differences among fabricated integrated circuits, including those associated with hardware trojans (HT), using cluster-ing-based analysis and/or harmonics-based analysis of side-channel evaluation. The exemplary method and system has been demonstrated to achieve detection of hardware differences as small as 0.19% of the total circuits with 100% accuracy while being tolerant to manufacturing variations among hardware instances.

### RELATED APPLICATION

This International PCT application claims priority to, and the benefit of, U.S. Provisional Patent Application No. 63/080,906, filed Sep. 21, 2020, entitled, “HARDWARE TROJAN AND MALICIOUS CIRCUITRY DETECTION METHOD AND SYSTEM IN INTEGRATED CIRCUITS USING CLUSTERING ANALYSIS,” which is incorporated by reference herein in its entirety.

### STATEMENT OF GOVERNMENT INTEREST

This invention was made with government support under grant nos. 156399, 1651273, and 1740962 awarded by the National Science Foundation, Grant no. FA8650-16-C-7620 awarded by the Defense Advanced Research Projects Agency, and grant nos. N00014-17-1-2540 and N00014-19-1-2287 awarded by the Office of Naval Research. The government has certain rights in the invention.

### BACKGROUND

As integrated circuits (IC) are being fabricated by IC vendors outside the control of IC designers and system integrators, the security of ICs is becoming a growing concern and issue as malicious hardware changes (also referred to as “hardware trojans” (HT)) could be injected into an IC by adversaries at any stage of the design and fabrication. HT insertion at the foundry is the most common scenario and is harder to secure.

Current hardware trojans typically include a trigger and payload circuit. The payload maintains the malicious function for the Trojan in a dormant state until it is triggered, and the trigger circuit constantly checks for the right conditions to activate the payload. Well-designed HTs are configured to trigger when very rare conditions are observed to make the detection of them difficult using conventional hardware function verification and testing.

Current methods to detect HT insertion at the foundry stage generally include randomly selecting ICs for reverse engineering or side-channel evaluation. Reverse-engineering techniques generally rely on destructive scanning of actual IC layout to re-build the GDSII and netlist level of the chip and are extremely time-consuming, expensive, and destructive of the tested IC. Side-channel evaluation is non-destructive but requires a “gold-sample” IC. The gold sample IC is also useful until updates are made to the design.

There is a benefit to improving the current screening methodology for fabricated IC.

### SUMMARY

An exemplary method and system are disclosed that can detect the presence or absence of hardware differences among fabricated integrated circuits, including those associated with hardware trojans (HT), using clustering-based analysis and/or harmonics-based analysis of side-channel evaluation. The exemplary method and system have been demonstrated to achieve detection of hardware differences as small as 0.19% of the total circuits with 100% accuracy while being tolerant to manufacturing variations among hardware instances.

The exemplary method and system can be used to significantly reduce the size of test samples for reverse engineering, thus enabling the deployment of reverse engineering approaches to a large population of ICs in a real testing scenario.

In an aspect, a method is disclosed to identify hidden hardware modifications (e.g., malicious hidden modifications) in circuitries of a fabricated integrated circuits, the method includes wirelessly applying RF waveforms to a plurality of fabricated integrated circuits to evaluate for hidden hardware modifications; wirelessly recording a plurality of signals (e.g., backscattering side-signal) of RF waveforms emanating from the plurality of fabricated integrated circuit, wherein each signal of the plurality of signals is recorded from a respective fabricated integrated circuit and is reflective of impedance characteristics of the respective fabricated integrated circuit; generating, by a processor, a plurality of clusters (e.g., k-means clusters) of the plurality of signals based on harmonics of the plurality of signals; and adjusting, by the processor, the number of the plurality of clusters based on distances of centroids in the plurality of clusters to identify, at least, a first group of fabricated integrated circuits and a second group of fabricated integrated circuits, wherein the first group of fabricated integrated circuits has a different impedance characteristic profile to the second group of fabricated integrated circuits, wherein a difference in impedance characteristic profile being present is indicative of a hidden hardware modification in the first group of fabricated integrated circuits or the second group of fabricated integrated circuits.

In some embodiments, the method further includes selecting at least one of the first group of fabricated integrated circuits or the second group of fabricated integrated circuits for destructive evaluation for the hidden hardware modification.

In some embodiments, the method further includes storing cluster data for the first group of fabricated integrated circuits or the second group of fabricated integrated circuits; comparing a subsequently generated plurality of clusters associated with a second plurality of fabricated integrated circuits to the cluster data; and rejecting the second plurality of fabricated integrated circuits associated with the subsequently generated plurality of clusters based on the comparison.

In some embodiments, each of the emanated RF waveforms comprises backscattering side-channel signals reflective of impedance characteristics of circuitries of the respective fabricated integrated circuit.

In some embodiments, the plurality of clusters are defined by a plurality of clustered elements each associated with the respective fabricated integrated circuit, and wherein each of the plurality of the clustered elements is generated by a dimensionality reduction algorithm (e.g., principal component analysis) applied to harmonics-based data (e.g., a difference of harmonics data) of a respective recorded signal for the respective fabricated integrated circuit.

In some embodiments, each clustered element of the plurality of clusters are generated by determining, by the processor, harmonic amplitudes (e.g., difference harmonic amplitude) of the given wirelessly recorded signal of the respective fabricated integrated circuit; and determining, by the processor, a singular value decomposition value (e.g., in a logarithmic scale) of the harmonic amplitudes.

In some embodiments, the plurality of clusters comprise k-mean-based cluster elements each determined based on one or more harmonic amplitudes of a respective recorded signal for the respective fabricated integrated circuit.

In some embodiments, the adjustment of the number of the plurality of clusters based on the distances of centroids comprises determining if a distance among edges of cluster centroids are below a pre-defined threshold.

In some embodiments, the adjustment of the number of the plurality of clusters based on the distances of centroids comprises determining if a distance among edges of cluster centroids are below a threshold determined by (i) determining, by the processor, distances among centroids of the plurality of clusters, (ii) determining, by the processor, a plurality of distances of a predefined number of nearest clusters (e.g., 2) for each cluster of the plurality of clusters, and (iii) establishing, by the processor, the threshold as a statistically-derived value (e.g., mean, mode, median) of the determined distances.

In some embodiments, the adjustment of the number of the plurality of clusters based on the distances of centroids comprises grouping a first cluster and a second cluster of the plurality of clusters if a distance of an edge of the first cluster and an edge of the second cluster is below a threshold (e.g., predefined or automatically determined); and grouping the first cluster and the second cluster if a path can be defined (e.g., in a shortest path algorithm) in a generated graph model comprising a first node associated with the first cluster and a second node associated with the second cluster.

In some embodiments, the harmonics of the plurality of signals comprise measured backscattering side-channel harmonics of clock signals of the respective fabricated integrated circuit.

In some embodiments, the hidden hardware modifications comprise one or more maliciously inserted circuitries configured to compromise operations of the fabricated integrated circuits.

In another aspect, a method is disclosed to identify hidden hardware modifications (e.g., malicious modifications) in circuitries of a fabricated integrated circuits, the method comprising wirelessly applying RF waveforms to a plurality of fabricated integrated circuits to evaluate for hidden hardware modifications; wirelessly recording a plurality of backscattering side-channel signals of the RF waveforms emanating from the plurality of fabricated integrated circuit, wherein each signal of the plurality of backscattering side-channel signals is recorded from a respective fabricated integrated circuit and is reflective of impedance of the respective fabricated integrated circuit; generating, by a processor, a plurality of clusters (e.g., k-means clusters) of the plurality of backscattering side-channel signals; and adjusting, by the processor, the number of plurality of clusters based on distances of centroids of the plurality of backscattering side-channel signals in the plurality of clusters to identify, at least, a first group of fabricated integrated circuits and a second group of fabricated integrated circuits, wherein the first group of fabricated integrated circuits has a different impedance profile to the second group of fabricated integrated circuits that is indicative of a hidden hardware modification being present in the first group of fabricated integrated circuits or the second group of fabricated integrated circuits.

In some embodiments, the plurality of clusters are based on backscattering side-channel harmonics of clock signals of the respective fabricated integrated circuit.

In some embodiments, the method further includes selecting at least one of the first group of fabricated integrated circuits or the second group of fabricated integrated circuits for destructive evaluation for the hidden hardware modification.

In some embodiments, the method further includes storing cluster data for the first group of the second group of fabricated integrated circuits; comparing a subsequently generated plurality of clusters to the cluster data; and rejecting a second plurality of fabricated integrated circuits associated with the subsequently generated plurality of clusters based on the comparison.

In some embodiments, each of the emanated RF waveforms comprises backscattering side-channel signals reflective of the impedance of circuitries of the respective fabricated integrated circuit.

In some embodiments, the plurality of clusters are defined by a plurality of clustered elements each associated with the respective fabricated integrated circuit, and wherein each of the plurality of the clustered elements is generated by a dimensionality reduction algorithm (e.g., principal component analysis) applied to harmonics-based data (e.g., a difference of harmonics data) of a recorded backscattering side-channel signal for the respective fabricated integrated circuit.

In some embodiments, each clustered element of the plurality of clusters are generated by determining, by the processor, harmonic amplitudes (e.g., difference harmonic amplitude) of a given wirelessly recorded signal of the respective fabricated integrated circuit; and determining, by the processor, a singular value decomposition value (e.g., in a logarithmic scale) of the harmonic amplitudes.

In some embodiments, the plurality of clusters comprise k-mean-based cluster elements each determined based on one or more harmonic amplitudes of a given wirelessly recorded signal.

In some embodiments, the adjustment of the number of the plurality of clusters based on the distances of centroids comprises determining if a distance among edges of cluster centroids are below a threshold.

In some embodiments, the adjustment of the number of the plurality of clusters based on the distances of centroids comprises determining if a distance among edges of cluster centroids are below a threshold determined by (i) determining, by the processor, distances among centroids of the plurality of clusters, (ii) determining, by the processor, a plurality of distances of a predefined number of nearest clusters (e.g., 2) for each cluster of the plurality of clusters, and (iii) determining, by the processor, the threshold as a statistically-derived value (e.g., mean, mode, median) of the determined distances.

In some embodiments, the adjustment of the number of the plurality of clusters based on distances of centroids comprises grouping a first cluster and a second cluster of the plurality of clusters if a distance of an edge of the first cluster and an edge of the second cluster is below a threshold; and grouping the first cluster and the second cluster if a path can be defined (e.g., in a shortest path algorithm) in a generated graph model comprising a first node associated with the first cluster and a second node associated with the second cluster.

In some embodiments, the harmonics of the plurality of backscattering side-channel signals comprises measured backscattering side-channel harmonics of clock signals of the respective fabricated integrated circuit.

In some embodiments, the hidden hardware modifications comprise one or more maliciously inserted circuitries configured to compromise operations of the fabricated integrated circuits.

In some embodiments, the hidden hardware modifications comprise a trigger circuit for maliciously inserted circuitries, the trigger circuit being at least 0.19% of the size of the fabricated integrated circuits.

In another aspect, a testing system is disclosed that is configured to perform any of the above-discussed methods.

In some embodiments, the testing system includes a test cell for a fabricated integrated circuit, the test cell comprising a first antenna to wirelessly apply a first RF waveform to the fabricated integrated circuit; a second antenna to wirelessly receive a second RF waveform emanating from the plurality of fabricated integrated circuit; and instrumentation to record the second RF waveform.

In some embodiments, the testing system includes an analysis system to perform an analysis comprising any of the above-discussed methods.

In another aspect, a non-transitory computer-readable medium is disclosed having instructions stored thereon, wherein the instructions, when executed by a processor, cause the processor to perform any of the above-discussed methods.

### BRIEF DESCRIPTION OF THE DRAWINGS

The patent or application file contains at least one drawing executed in color. This application is directed to the evaluation of the field of view of a person. Evaluative scenes and results, as presented in color, may be necessary for the understanding of the claims. Copies of this patent or patent application publication with color drawing(s) will be provided by the Office upon request and payment of the necessary fee.

Embodiments of the present invention may be better understood from the following detailed description when read in conjunction with the accompanying drawings. Such embodiments, which are for illustrative purposes only, depict novel and non-obvious aspects of the invention. The drawings include the following figures.

FIG. 1 shows an exemplary method to identify hidden hardware modifications (e.g., malicious hidden modifications) in circuitries of fabricated integrated circuits in accordance with an illustrative embodiment.

FIG. 2 shows an example test system configured to perform method of FIG. 1 in accordance with an illustrative embodiment.

FIG. 3 shows the impact of hardware trojans on impedance measurements in backscattering side-channel signal analysis in accordance with an illustrative embodiment.

FIG. 4A shows an example clustering operation of the method of FIG. 1 in accordance with an illustrative embodiment.

FIG. 4B shows an initial clustering operation performed in the clustering operation of FIG. 4A in accordance with an illustrative embodiment.

FIG. 5A shows another example test system configured to perform method of FIG. 1 in accordance with an illustrative embodiment.

FIGS. 5B and 5C show the experimental results of the distribution of distances between clusters.

FIG. 6 shows the output of the clustering operation of FIG. 1 for various HT test cases in accordance with an illustrative embodiment.

FIG. 7 shows the output of the clustering operation of FIG. 1 for varying sizes of one type of modified hardware circuit in accordance with an illustrative embodiment.

FIGS. 8A and 8B show the outputs of the clustering operation of FIG. 1 for a ground truth sample set and a set of modified hardware circuits of varying trigger circuit sizes in accordance with an illustrative embodiment.

FIG. 9 shows the workflow for integrated circuit fabrication and the areas of risk of hardware trojan insertions.

FIG. 10 illustrates different classes of hardware trojans to which the clustering operation of FIG. 1 may be used to evaluated in accordance with an illustrative embodiment.

### DETAILED SPECIFICATION

Each and every feature described herein, and each and every combination of two or more of such features is included within the scope of the present invention provided that the features included in such a combination are not mutually inconsistent.

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. All references cited and discussed in this specification are incorporated herein by reference in their entireties and to the same extent as if each reference was individually incorporated by reference.

### Example Method

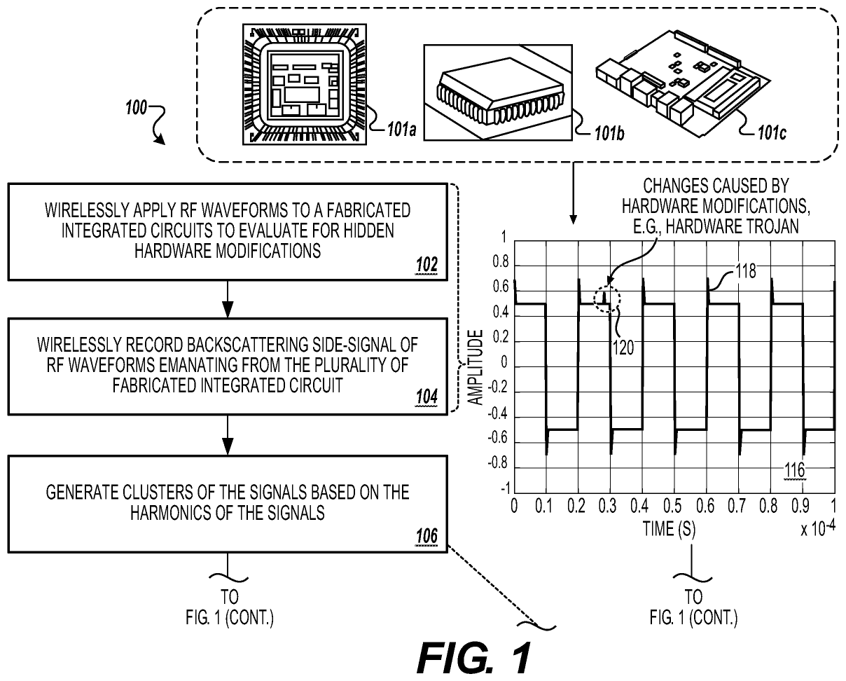

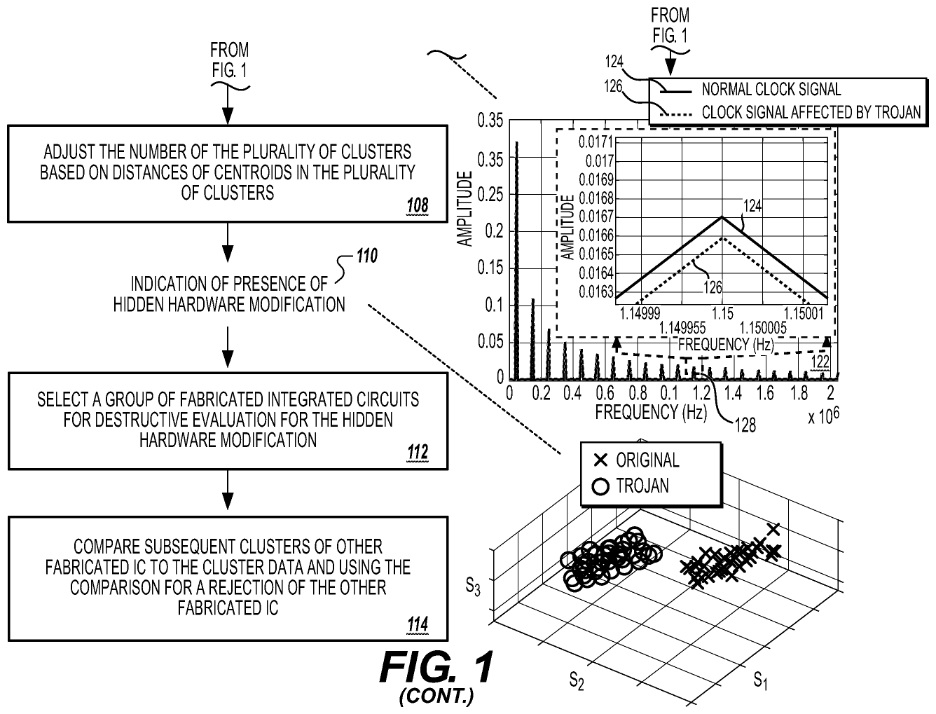

FIG. 1 shows an exemplary method 100 to identify hidden hardware modifications (e.g., malicious hidden modifications) in circuitries of fabricated integrated circuits 101 in accordance with an illustrative embodiment. The term “fabricated integrated circuits,” as used herein refers to a set of integrated electronic circuits manufactured on a piece of semiconductor material. As shown in the example of FIG. 1, fabricated integrated circuits 101 (shown as 101a, 101b, 101c) that can be evaluated using Method 100 can include the fabricated semiconductor die prior to being packaged (101a), fabricated chips comprising the fabricated semiconductor die as integrated into a package (101b), as well as fabricated chips that as integrated into printed circuit boards (101c).

Method 100 includes wirelessly applying (102) RF waveforms to a plurality of fabricated integrated circuits to evaluate for hidden hardware modifications and wirelessly recording (104) a plurality of signals of RF waveforms emanating from the plurality of fabricated integrated circuit, e.g., in a side-channel analysis operation such as backscattering side-channel analysis operation. Each signal of the plurality of signals is recorded from a respective fabricated integrated circuit and is reflective of impedance characteristics of the respective fabricated integrated circuit. Side-channel analysis operation relies on the measurement of some non-functional properties of the IC from outside the IC while it operates and comparing the measurements to reference signals. Specifically, each of the emanated RF waveforms can include backscattering side-channel signals reflective of impedance characteristics of circuitries of the respective fabricated integrated circuit. Backscattering side-channel analysis operation attempts to measure impedance switching activities inside the chip by propagating a continuous wave signal, namely, the RF waveforms, toward the chip. The transistor switching activities cause changes in the chip impedance, which modifies the radar cross-section (RCS) of the circuit. This RCS change modulates the signal that is backscattered (reflected) from the chip, which creates an impedance-based backscattering side channel.

Here, rather than using simulation (e.g., as described in [8]-[10]) or comparing the recording to a “golden-sample” device, the exemplary method 100 employs the clustering method as a means to determine if a set of evaluated ICs has a different electromagnetic-frequency (i.e., radar) cross-section (RCS) of the circuit. The clustering operation can be used to select at least one of the first group of fabricated integrated circuits or the second group of fabricated integrated circuits for destructive evaluation for the hidden hardware modification. Subsequently, the cluster data for a golden sample can be stored as the cluster data for a golden sample, and used for subsequent comparison (114) to cluster and reject other batches of fabricated integrated circuits. This first clustering operation can classify a large population of ICs into clusters without itself having a “golden” (known-to-be-HT free) chip and with no prior knowledge about the circuitry of the fabricated IC being tested. The classification can be performed with relatively low testing complexity and cost. Notably, the operation addresses the technical challenges of consolidating clusters in a meaningful way that distinguishes a group of IC from another group of IC that is slightly different in topology (e.g., as small as 0.19% of the fabricated integrated circuits) and validating that the consolidation operation for the impedance-based backscattering side channel.

In the example of FIG. 1, plot 116 shows a simulated clock signal with noise 118 of a fabricated IC that is configured with a hardware trojan circuit comprising trigger and payload circuits. Plot 116 shows an example side-channel analysis signal 120 associated with the trigger circuit that is caused by an impedance change from the operation of that trigger circuit. The impedance change generally looks like noise but occurs in a periodic and non-stochastic manner.

To identify whether multiple actual clusters exist, Method 100 includes generating (106) a plurality of initial clusters (e.g., using k-means clusters) of the plurality of signals based on harmonics of the plurality of signals. Method 100 then includes adjusting (108), by the processor, the number of the plurality of clusters based on distances of centroids in the plurality of clusters to identify, at least, a first group of fabricated integrated circuits and a second group of fabricated integrated circuits. To be later discussed, in some embodiments, the adjustment (108) may be based on (i) the determination if the nearest distance of an edge of a first cluster and an edge of a second cluster is below a certain threshold and (ii) a graph analysis that can assess if the clusters are connected. The first group of fabricated integrated circuits has a different impedance characteristic profile to the second group of fabricated integrated circuits, and this indication (110) based on the difference in impedance characteristic profile can be outputted to indicate the presence of a hidden hardware modification being present in the first group of fabricated integrated circuits or the second group of fabricated integrated circuits. The clusters may be initially defined by a pre-defined number of clusters derived from the plurality of clustered elements, e.g., centroid or cluster boundaries, each associated with the respective fabricated integrated circuit.

The indication 110 may be a binary output, a data output, or visualization of that data showing the presence of two or more distinct clusters (i.e., an indication of modified hardware in the group of tested ICs) or the presence of a single cluster (i.e., an indication of no modified hardware in the group of tested ICs). Plot 130 shows an example of a visualization output showing the presence of two distinct clusters indicative of the presence of modified hardware, potentially malicious, being present the tested group of ICs. The indication 110 can be used to direct (112) the destructive evaluation of an IC selected from one or both of the identified clusters to determine the presence of the cluster group comprising hidden hardware modification and a normal IC group. Indeed, the indication 110 reduces the number and/or the extent of destructive evaluation for the group of ICs to determine if the tested IC belongs to a set of ICs that can be assigned the label of a golden sample or modified sample while providing high confidence that the non-tested group is the opposite of that. To this end, the normal IC group, and its associated cluster data, can be assigned the label of a golden sample and can be used to subsequently evaluate (114) other subsequent groups of ICs. Of course, the cluster data of the modified hardware group can also be used for subsequent comparison, if desired.

To emphasize the separation between ICs with malicious hardware and normal ICs, the clustering analysis (e.g., performed in step 108) may be performed on harmonics-based data of the respective recorded signal for the respective fabricated IC. Plot 122 shows the clock signal of plot 116 in the frequency domain. The side-channel analysis signal 120, in the frequency domain, can be view as a difference in amplitude that can characterize, e.g., by amplitude ratios. Plot 122 shows a harmonics 124 for the normal clock signal of a normal IC and the harmonics 126 for the modified IC of plot 116. For the clustering analysis, to represent each fabricated IC with a single cluster element, a dimensionality reduction algorithm (e.g., principal component analysis) can be applied to the harmonics-based data (e.g., a difference of harmonics data), e.g., to identify the harmonics of interest (e.g., shown as 128).

### Example System

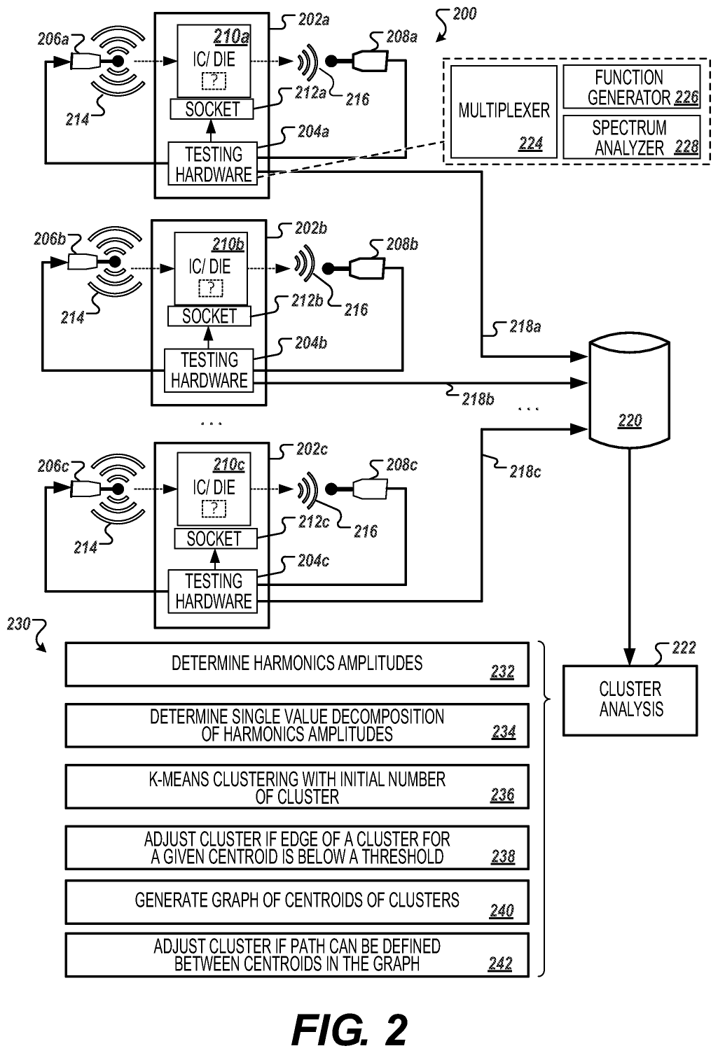

FIG. 2 shows an example test system 200 configured to perform method 100 of FIG. 1 in accordance with an illustrative embodiment. Test system 200 includes one or more test cell 202 (shown in this example as 202a, 202b, 202c) each comprising test instrumentation 204 (shown as “Testing Hardware” 204a, 204b, 204c) that is coupled to (i) a test transmitting antenna 206 (shown as 206a, 206b, 206c) configured to wirelessly apply (102) the RF waveforms (214) to the fabricated integrated circuits 101 (shown as 210a, 210b, 210c, respectively) and (ii) a test receiving antenna 208 (shown as 208a, 208b, 208c) configured to record (104) RF waveforms (216) emanating from the fabricated integrated circuit 210. The test instrumentation 204 can provide the recorded RF waveforms 218 (shown as 218a, 218b, 218c) to a storage device 220 to be retrieved by an analysis system 222 (shown as “Cluster Analysis” system 222) to perform the cluster analysis (e.g., operations 106, 108) of FIG. 1. In the example of FIG. 2, the cluster analysis (e.g., operations 106, 108) can include the sub-operations 232, 234, 238, 240, and 242.

To test a fabricated semiconductor die 101a or a fabricated chip 101b, in the example shown in FIG. 2, e.g., the fabricated integrated circuit 210 is attachable-ably coupled to a socket 212 (shown as 212a, 212b, 212c) comprising mechanical components to make mechanical and electrical connections between the fabricated integrated circuit 210 and a printed circuit board (not shown) that couples to the test instrumentation 204. The test instrumentation 204 can provide power and ground connections to the pins of the fabricated integrated circuit 210 as well as digital IO or bus communication connections to the fabricated integrated circuit. In the example shown in FIG. 1, the test instrumentation 204 can couple to one or more clocks of the fabricated integrated circuit 210.

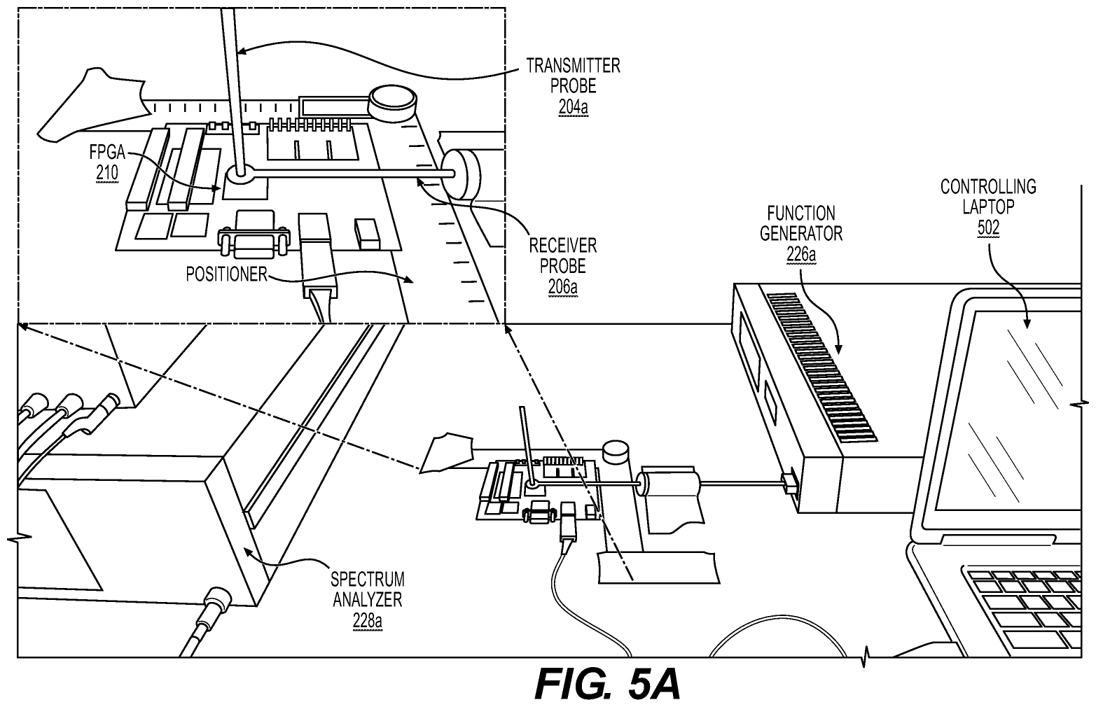

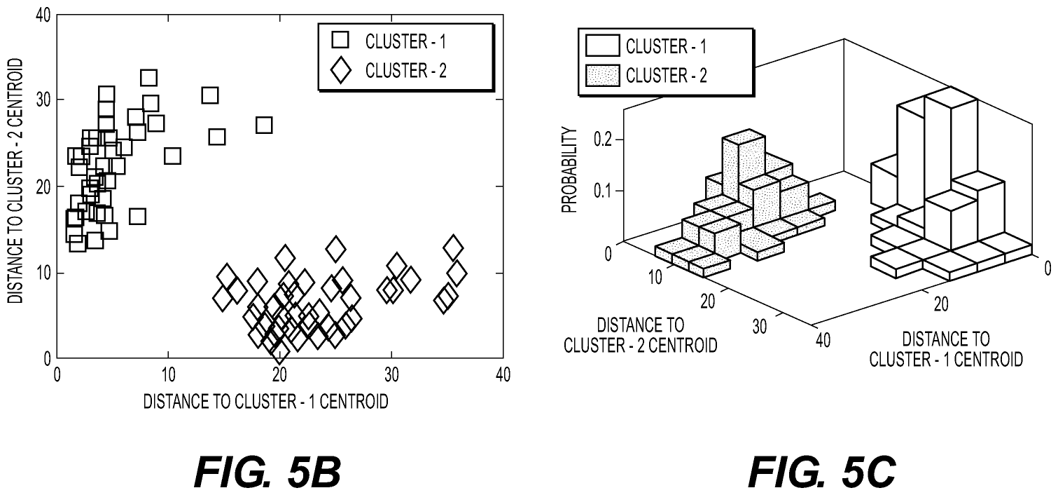

The test system 200 of FIG. 2 can perform multiple evaluations in parallel. In some embodiments, the test instrumentation 204 includes one or more multiplexors (224) to select the inputs and outputs (e.g., to antennas 204, 206) of the test cell of the fabricated integrated circuit being evaluated. In alternative embodiments, the instrumentations can be manually instrumented for different ICs under evaluated. FIG. 5A shows a test system 200 (shown as 200a) comprising a single test cell 202. The test system 200 can include a function generator 226 and a spectrum analyzer 228 to generate the test RF waveforms (214) and to receive the RF waveforms (216) emanating from the fabricated integrated circuit 210.

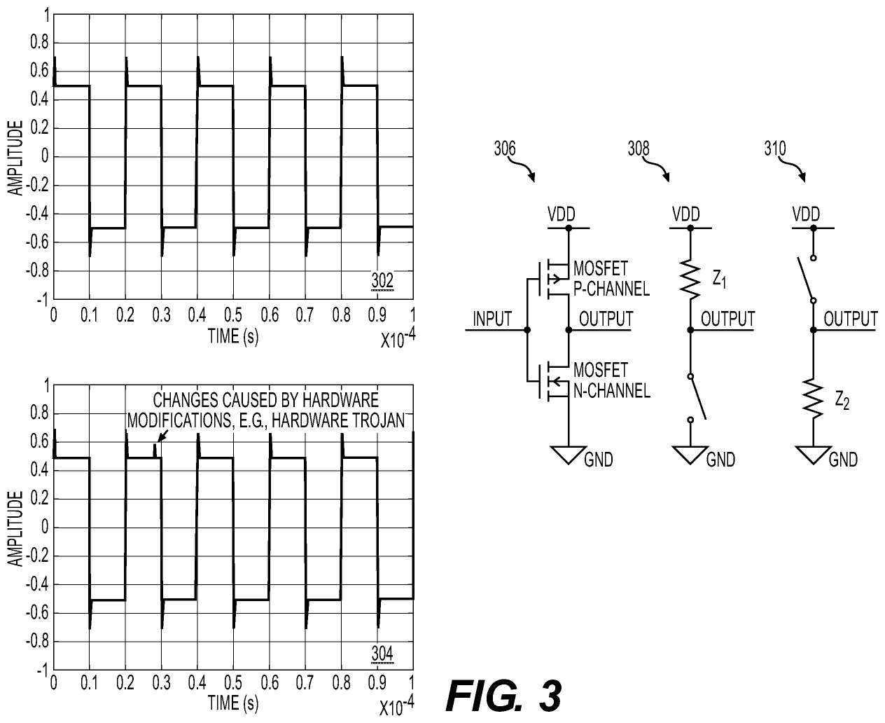

Backscattering Side-channel Signal Analysis. It has been reported that backscatter side-channel signals can observe and characterize the impedance characteristic profile of a fabricated IC. Nguyen et al. [11] has shown that HTs can be detected by analyzing impedance changes within sub-clock samples, where the changes caused by HTs happen and can be observed on the clock signal. FIG. 3, plot 302, illustrates an example of a clock signal modeled as a square wave with added Gaussian noise. FIG. 3, plot 304 (previously shown as 116 in FIG. 1), shows an example of a clock signal affected by HTs. As shown in plots 302 and 304, the backscattered signal of sub-clock samples can be captured where the changes caused by HT can be observed, to which a system can detect the presence of HTs. However, analysis in the time-domain signal can be more prone to noise; therefore, more difficult to extract and synchronize measurements to get samples where changes caused by HTs happen. Additional description and example of backscattering side-channel signal operation to which the exemplary clustering and testing operation can be applied can be found in U.S. Patent Application No. 2021/0073381 and in reference [11], which is incorporated by reference.

FIG. 3 shows an example of a CMOS inverter 306 and its equivalent impedance circuits when the output is high (308) and low (310), respectively. The impedances (308 and 310) are different because the geometry and doping levels of PMOS and NMOS are not exactly the same. As a result, this impedance switching can change the circuit's RCS, thus modulates the signal that is backscattered from the circuit with the information about impedance changes in the system to create the backscattering side-channel.

Harmonics Analysis. In the example shown in FIG. 2, the cluster analysis system 222 can determine (232) the amplitudes of the harmonic of the backscatter side-channel signals by performing a short Time Fourier transformation (STFT) on time-domain signal (of the backscatter side-channel signals) to observe the signal in the frequency domain. The cluster analysis system 222 can then observe which frequency components of the time domain signal are affected when a dormant HT is present. As discussed above, to emphasize the separation between ICs with malicious hardware and normal ICs, the clustering analysis (e.g., performed in step 108) may be performed on harmonics-based data of the respective recorded signal for the respective fabricated IC. Indeed, the changes in the observed backscatter side-channel signals caused by HTs can occur abruptly at some point in the clock cycle.

FIG. 1, plot 122, shows Trojan-free and Trojan-affected clock signals in the frequency domain from an FFT operation performed on the signals given in plots 302 and 304, respectively. The signals in the frequency domain are indeed more readily identifiable and measurable as the noise power, which tends to be quite stochastic, can be very small from the perspective of a single frequency bin. The change caused by HTs can be reflected in backscattered signals at the circuit's clock harmonics: f_{carrier}±f_{c}, f_{carrier}±2*fc, etc. The first clock harmonic at f_{carrier}±fc can follow the overall RCS change during a cycle, while the remaining harmonics can be affected by the rapidity of change (rise/fall times) and timing of the impedance changes within the clock cycle.

As changes caused by HTs in the time-domain signal become briefer in duration, the changes among clock harmonics become smaller in magnitude and shift to higher harmonics which, compared to lower harmonics, tend to be affected more by noise. To wit, backscattering side-channel can work better for HT detection than other traditional analog side-channels such as EM and Power side-channels. Backscattering side-channel is typically a consequence of the impedance changes in digital switching circuits, which can be caused by the transistors' two-state impedances reflecting a modulated signal. For each gate that switches, the impedance change would persist for the rest of the cycle. In contrast, EM and power side-channels are the consequences of the variation of the current flow in a circuit. As a gate switches, the current will be charged or discharged quickly, which means a current burst can occur for a very short period of time and thus provide for a shorter detection event.

Single Value Decomposition Operation. In the example shown in FIG. 2, the cluster analysis system 222 can determine (234) a single value decomposition value of the amplitudes of the harmonics. To generate the single value decomposition for each data of the fabricated IC, the cluster analysis system 222 can first generate a vector of the measure of the amplitude of the first N harmonics of the clock from its backscattering side-channel signals in which the vector characterizes the circuit's overall amount, timing, and duration of impedance-change activity during a clock cycle. If there is a hardware Trojan in the fabricated IC, this vector would be different from the ones recorded from an HT-free same circuit.

In some embodiments, the cluster analysis system 222 can represent each fabricated IC (210) by a vector of N points comprising the amplitudes of the first N harmonics of the clock from its backscattering side-channel signals: h=[h₁, h₂, . . . , h_{N-1}, h_{N}], where hⱼ is the amplitude of the jₜₕ harmonic of the clock.

The cluster analysis system 222 can then determine the amplitude ratio of the amplitude itself to cancel out the attenuation caused by the distance that affects all harmonics. The system may convert harmonic ratios from linear-domain to dB-domain to prevent the magnitude dominance of the top ratios, and to increase the effect of small harmonic ratios. Matrix Y is the matrix containing the harmonic ratios of all boards which can be written as Equation 1:

$$Y = [ \begin{matrix}- & y & - \\ - & {y}_{2} & - \\ & … & \\ - & {Y}_{M} & -\end{matrix} ] \qquad ( Eq . 1 )$$

where M is the number of boards, and the vector yᵢ of amplitude ratios can be calculated as yᵢ=[yᵢ₁, yᵢ₂, . . . , y_{i(N-1)}] in which i is the IC being evaluated and yᵢⱼ=10* log₁₀(hᵢ(j+1)/hᵢ(j)) where hᵢ∈ [symbol] ^{N} is a vector containing the harmonic amplitudes for the i^{th} IC. The objective is to reveal the hidden information that could be crucial to identifying Trojans in the data by removing the redundant information.

To reduce the dimensionality of the vector, i.e., to generate a single value decomposition value, the cluster analysis system 222 can employ principle component analysis (PCA) on the vector Y per Equation 2.

Y=UΣV^{T} ( Eq. 2)

The first m singular values can be the largest m singular values of the matrix Y, and Vₘ is a submatrix with the first m columns of V corresponding to these m singular values. Therefore, to reduce the size of the data, the system can project Y onto the column space of Vₘ per Equation 3:

Y_{P}=YVₘ (Eq. 3)

where the value of m can be selected so that the power of the projected data is very close to the power of Y per Equation 4.

∥Y_{P}∥_{F}/∥Y∥_{F}≈1 (Eq. 4)

In Equation 4, ∥○∥ is the Frobenius norm of its argument. For example, when m=3, Y_{P} can captures 99% of the power of Y, and sⱼ can denote the singular value direction corresponding to j^{th} largest singular value.

K-means clustering. In the example shown in FIG. 2, the cluster analysis system 222 can determine (236) an initial cluster of the ICs being evaluated using K-mean clustering. This initial cluster will be modified so that each cluster corresponds to different board groups due to production variability, or existence of a hardware trojan. To find the initial clusters and corresponding centroid points, the k-means algorithm can be performed that set the initial number of clusters, N_{C}, and their initial locations as L_{c}∈ [symbol] e^{N}^{_{c}}^{×m}. Each row can represent the location of the corresponding cluster. To allow the algorithm to converge to a local optimum and ensure wide separation of the centroids, the cluster analysis system 222 can initiate the k-means algorithm by: (1) choosing a random sample from the projected data as the location of the first cluster; (2) finding a sample whose total distance is the furthest away from the previously chosen clusters; and (3) repeating (1) and (2) until all centroids are initialized.

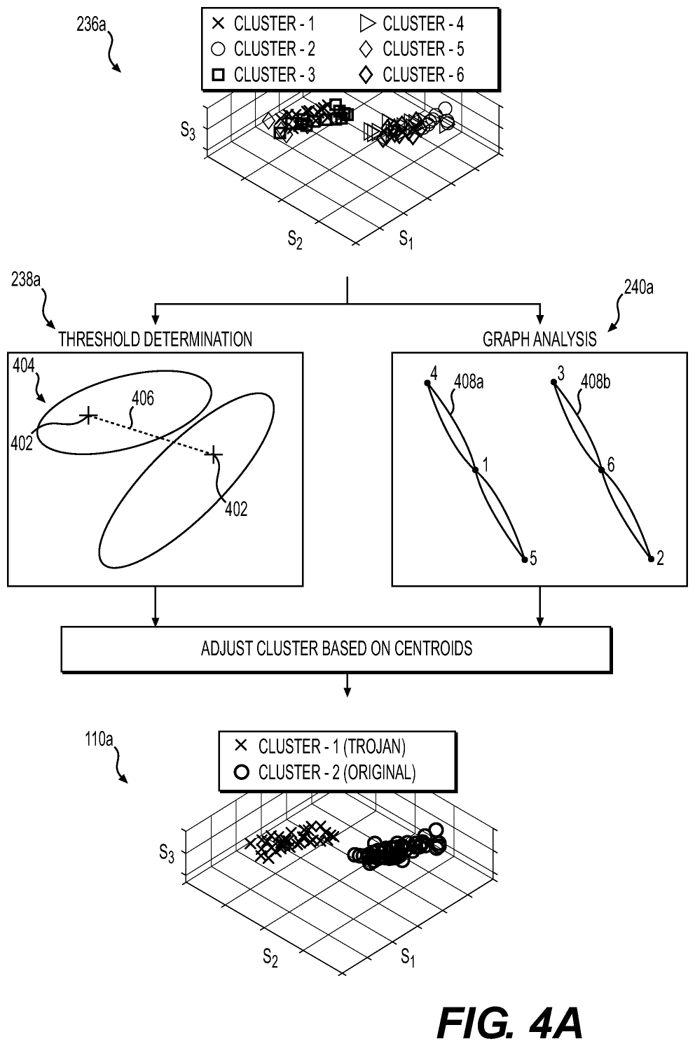

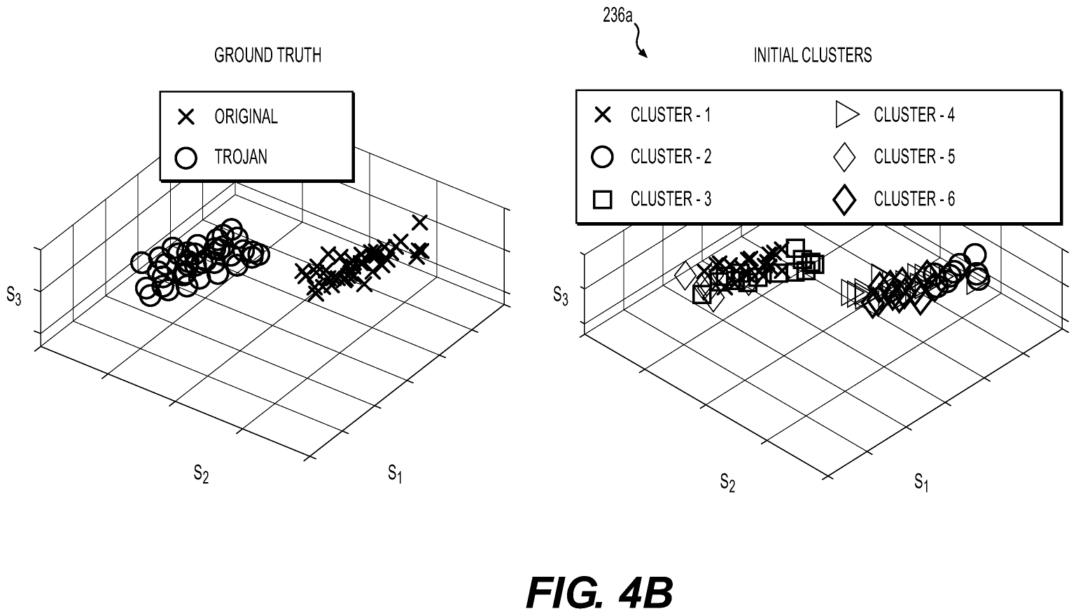

The initial cluster includes N_{C} number of clusters that would be larger than the actual number of clusters in the data, i.e., larger than the number of Trojan types. Because there is no information on how many types of Trojan may exist in the testing devices, a large number is initially used for N_{C}. FIG. 4A shows an example of the operations 234, 236, 238, 240, 242 of FIG. 2 as operations 234a, 236a, 238a, 240a, 242a, respectively. In the example of FIG. 4A, the K-means clustering output having an initial cluster number N_{C}=6 is shown. FIG. 4B shows the initial cluster as compared to the ground truth data provided as an illustration of this example—as noted above, the cluster operation during run-time does not have prior information about the IC being tested. In FIG. 4B, by comparing the initial clusters to the ground truth data, it can be observed that there is no cluster that contains both the original and Trojan-affected circuits. Indeed, following the initial cluster generation, the number of clusters has to be decreased in a meaningful and reliable manner to reveal the true number, i.e., cluster, of Trojan-affected circuits.

Graph-based Analysis. To decrease the number of clusters, in the example shown in FIG. 2, the cluster analysis system 222 can perform (240) a graph operation and the shortest path algorithm. The cluster analysis system 222 can generate the graph in which two centroids belong to the same group if they are at the edges of the same arc. It is noted that the “group” indicates the Trojan type or whether the board is Trojan-affected. The proposition is that the group of two closest clusters are the same if the distance of these clusters are below some threshold. In other words, the cluster analysis system 222 can constrain (238) the arcs such that an arc is valid only if the distance between the cluster centroids at the edges is smaller than a given threshold. In the example of FIG. 4, to obtain the threshold automatically, the cluster analysis system 222 can (1) calculate the distance (406) among centroids (402); (2) choose the closest two clusters (404) for each cluster, and keeping the distances (406) in a list; and (3) assign the threshold as the mean distance of this list.

The cluster analysis system 222 can then generate a graph of the clusters. FIG. 4 shows the graph 408 (shown as 408a and 408b) being generated (240a) based on the distances between the centroids of the clusters in which the nodes corresponding to the same classes are connected. The generated graph 408 can then be used to group clusters by identifying the valid arcs defined as whether a node is reachable from other nodes. Specifically, the cluster analysis system 222 can determine if there exists a path between any two nodes and label these nodes as the same type or group. In some embodiments, to obtain the connected nodes automatically, the cluster analysis system 222 can employ the shortest path algorithm [36] to check (242a) whether a node, i.e., a cluster, is reachable from another node. The algorithm can return a null if there is no path between two given nodes and a path if these two nodes are reachable. Based on the outcome of the shortest path analysis (242a), the cluster analysis system 222 can relabel the sample space indicating whether the connected nodes met the criteria. In the example shown in FIG. 4A, the output 110 (shown as 110a) is the true number of clusters. Indeed, while the exact identity of identified groups of IC is not known, the groups can be divided into batches that contain circuit designs that are not identical.

### Experimental Results and Additional Examples

A study was conducted to evaluate the performance of the clustering operation system 222.

Experimental Setup. FIG. 5A shows an example measurement setup for IC clustering using backscattering side-channel collection for HT detection. In the study, and shown in FIG. 5A, the test setup included (i) a transmitter 204 (shown as “Transmitter probe” 204a) comprising an Aaronia E1 electric-field near-field probe [37] that was connected to an Agilent MXGN5183A signal generator [38] 226 (shown as “function generator” 226a), and (ii) a receiver 206 (shown as 206a) comprising an Aaronia H2 magnetic-field near-field probe [37] that was connected to an Agilent MXA N9020A spectrum analyzer [39] 228 (shown as 228a).

The devices-under-test (DuT) (210) were Altera DE0 Cyclone V FPGA boards [40]. An angle ruler is used as a positioner so that different DE0-CV boards can be tested using approximately the same probe positions. A controller 502 comprising a laptop is used to control the devices and automate the measurements. In the study, the signal generator 226a generated a 3 GHz continuous sinusoid signal, and the spectrum analyzer 228a recorded the backscattered signals emanating from the tested device 210.

The measurements were carried out in an open environment setup at room temperature. The effect of environmental conditions such as temperature and voltage source, if existed, should be the same for all clock harmonics, and the exemplary technique is based on the ratio between clock harmonics. As a result, environmental conditions do not significantly affect the accuracy of the exemplary technique.

The study used FPGA instead of taping out ASICs for evaluation to provide flexibility, reduce the time for fabrication, and reduce cost. The results can be generalized to ASICs, semiconductor dies, integrated circuits such as microprocessors, microcontrollers, digital signal processors, bus interfaces, as various fabricated digital and analog circuitries. Indeed, although the same gate-level design would be smaller in an ASIC, the backscattered signal corresponding to the relative change in impedances and the relative change of impedances tend to be larger for smaller circuits. To this end, as the overall circuit gets smaller, say in transitioning the same design from the FPGA to an ASIC, the HT's trigger circuit would proportionally reduce in size, and the backscattering-based approach would work as well or possibly even better.

Hardware Trojan Benchmark Implementation. To evaluate the exemplary method, the study implemented three different benchmark circuits: AES, RS232, and PIC16F84, from the TrustHUB Trojan repository [41]. The benchmark circuits included a total of 21 Trojan designs for the AES circuit, 4 Trojan designs for the PIC16F84 circuit, and 21 Trojan designs for the RS232 circuit. Because numerous HTs in the TrustHub repository are similar to each other, the study selected circuits that exhibit different approaches for their triggers and payloads. Each of these Trojan designs had a different triggering mechanism, such as observing a specific sequence of the input, counting the number of encryption rounds, observing the number of execution of specific instructions, among others. The evaluated Trojan hardware also implemented different payload functionalities such as shortening the hardware lifetime, leaking private keys, changing the address to program memory, among others.

Table 1 summarizes the benchmarked Trojan hardware and their respective circuit size evaluated in the study.

TABLE 1

| | Size of Trojan | | |
|---|---|---|---|
| | (Percentage of HT-free circuit) | | |
| Benchmark | Trigger | Payload | Total |
| AES-T1200 | 0.32% | 1.61% | 1.93% |
| AES-T500 | 0.28% | 1.51% | 1.79% |
| AES-T700 | 0.27% | 1.76% | 2.03% |
| PIC16F84-T100 | 1.34% | 1.81% | 3.15% |
| PIC16F84-T300 | 1.37% | 1.96% | 3.33% |
| PIC16F84-T400 | 1.35% | 1.75% | 3.10% |
| RS232-T300 | 1.47% | 1.58% | 3.05% |
| RS232-T600 | 1.50% | 1.48% | 2.98% |
| RS232-T901 | 1.53% | 1.61% | 3.11% |

The Trojan-affected and Trojan-free designs were carefully mapped to the FPGA by using ECO (Engineering Change Order) tools so that they could have the same layout except for the Trojan part, thus making for a fair comparison. Indeed, while it is extremely hard to activate an HT without prior knowledge of its triggering circuit, an HT detection technique should be able to detect HT when it is dormant. To this end, the study focused on evaluating the exemplary method for dormant HTs in which all HT payloads stayed inactive in all experiments.

Testing Scheme. All HT benchmarks were implemented on an Altera DE0 Cyclone V FPGA board. The study tested 100 boards by randomly infecting the boards with one of the aforementioned HT. To simulate and mimic a real testing environment, for each HT benchmark, the study randomly programmed each of the 100 boards with HT-free or HT-infected designs and recorded its backscattering side-channel signals while the board is running. For each board, the study extracted the amplitude of the first 40 harmonics of the clock from its backscattering side-channel signal. The study employed the first 40 harmonics because the higher harmonics are often very weak and below the noise level. As a result, for each hardware Trojan benchmark, the study had a set of 100 traces in which each trace contained 40 points, denoted as follow: hᵢ=[hᵢ₁, hᵢ₂, . . . , h_{iN-1}, h_{iN}], where N=40, and 1≤i≤40. The exemplary clustering algorithm employed these traces as inputs to the cluster operation 222.

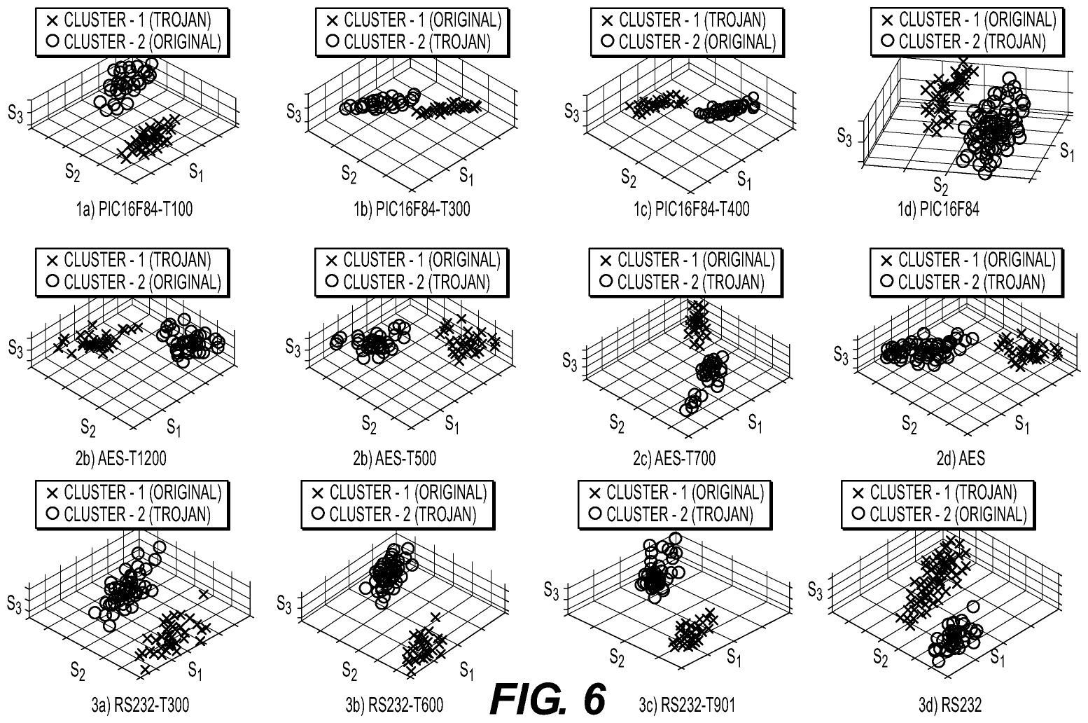

Evaluation of Existing HT Benchmarks. The trojan detection process can be summarized as follows: (a) collect the data from all boards with the setup given in FIG. 6 (the number of boards tested for the experiments is 100); (b) take the ratios of the consecutive harmonics and convert them into dB-domain; (c) collect the harmonic ratios for all boards in a matrix to generate Y; and d) obtain SVD of Y and project it into the space defined by the right-singular vectors corresponding to the largest m singular values to generate Y_{P}. Here, m was chosen such that it is the smallest number of singular values satisfying the condition ∥Y_{P}∥_{F}/∥Y∥_{F}≈0.999. The process further included applying the k-means algorithm by ensuring N_{C} is larger than the number of possible Trojan types. The initialization (236) of the centroids was based on the procedure discussed above. The process included generating (236, 238, 240) the graph of similarity with respect to a threshold. The process further included applying (242) the shortest path algorithm to reveal possible classes in the sample space. If the algorithm returns more than one cluster, the batch of boards contains some Trojan-affected boards.

The accuracy of the measurements may be defined as Equation 5.

$$Accuracy ( \% ) = \frac{\# of correct labels}{\# of measurements} \times 100 \qquad ( Eq . 5 )$$

The actual labels of the circuits were only employed to calculate the accuracy of the clustering system 222 per Equation 5.

In the study, after having the outcome clusters, the study first identified the group which contains most of the original designs and then labeled this group as Trojan-free circuits and the rest as the Trojan-affected circuits. Finally, the study compared the labels with the actual labels to calculate the accuracy. If the proposed method classified all the original designs in a cluster, and if this cluster does not contain any samples from Trojan-affected designs, the accuracy of the algorithm will be equivalent to 100%.

Results. FIG. 6 shows the results of the clustering separation (110) of the Trojan-free and the Trojan-affected circuits as produced by the clustering operation for each of the respective evaluated HT. The first three columns contain the plots (1a, 1b, 1c, 2b, 2a, 2c, 3a, 3b, and 3c) in which a Trojan exists, and the last column (1d, 2d, and 3d) included all three Trojan types.

The study first evaluated the PIC16F84 circuit with three different Trojan designs. The results were plotted by considering the singular vectors corresponding largest three singular values. FIG. 11 (subplots 1a-1d) shows the outcome of the evaluation of the PIC16F84 circuit. As noted above, FIG. 11, subplots 1a-1c shows the cluster results for the PIC16F84 circuit configured with 1 HT type, and subplot 1d shows the same circuit board configured with 3 HT types. Indeed, the number of singular values used for these experiments that satisfied the condition given in Equation 4 is 10, and N_{C}=6.

FIGS. 5B and 5C show (a) the calculated distances of the clusters of each circuit to the cluster centroids and (b) the distribution of distances of each circuit to each cluster centroid. The sample distances were plotted to each cluster centroid in FIG. 5B and their distribution in FIG. 5C for the samples given in FIG. 6, subplot 1a. The mean distances of “Cluster −1” samples to the centroids were 4.96 and 22.27 with standard deviations 3.47 and 5.03, whereas the mean distances of “Cluster—2 samples” were 23.39 and 6.08 with standard deviations 5.46 and 2.95, respectively. The clustering method achieved 100% accuracy for all of the experiments. It is noted that the legends of the figures are labeled for readability with the ground truth information included of whether the group are Trojan-affected or not. In the study, the experiments were conducted blind, and no such information was available—only information that the sample space contains two different groups (as the output of the analysis) were available.

FIG. 6, subplots 2a-2d and 3a-3d show the results of the other experiments conducted with the AES and RS232 circuits, respectively. FIG. 6, subplots 2a-2c and 3a-3c show results of test boards configured with one trojan design for AES and RS232, respectively, and FIG. 6, subplot 2d and 3d shows results of test boards configured with three trojan designs for AES and RS232, respectively. The study used the same number of clusters, N_{C}, as the evaluation of the PIC16F84 circuit. For these experiments, the number of singular-values satisfying the equation given in Equation 4 corresponds to 12 for each circuit. Similarly, the study obtained 100% accuracy for all these experiments meaning that all the original circuits are separated from the designs that are Trojan-affected, and clustered in a single group.

From the study, it was concluded that the backscattering side-channel operation is a viable mechanism to detect the existence of a Trojan when analyzed using the ratios of the harmonics. The separation between the Trojan-free and Trojan-affected circuits was observed to be significant. The study also concluded that the exemplary methodology (backscattered signal plus PCA and k-means algorithm) enables a perfect clustering of the Trojan-free and Trojan-affected circuits. The study also concluded that when multi-Trojan designs are considered, they still behave like a single group, and the proposed method can successfully distinguish the existence of at least two different classes.

Evaluation of Changing Size of Hardware Trojan Triggers. The study further explored the performance of the exemplary clustering operation for differing sizes of HTs. In [11], it was demonstrated that only the trigger is active while the payload stays inert when hardware Trojans are dormant; thus, if the trigger is big enough, the Trojans can be detected regardless of its payload size. The study extended this work by changing the size of the trigger to test the limits of the clustering operation. The study chose the RS232-T300 circuit for this evaluation because the trigger of this HT type can be meaningfully resized. Table 2 shows the different sizes of the RS232-T300 trigger circuit. In the evaluation, the payload circuit size was maintained constant, and the payload was kept dormant.

TABLE 2

| | Size of Trojan's Trigger |
|---|---|
| Benchmark | (Percentage of HT-free circuit) |
| RS232-T300 w/½ Trigger Size | 0.76% |
| RS232-T300 w/¼ Trigger Size | 0.39% |
| RS232-T301 w/⅛ Trigger Size | 0.19% |

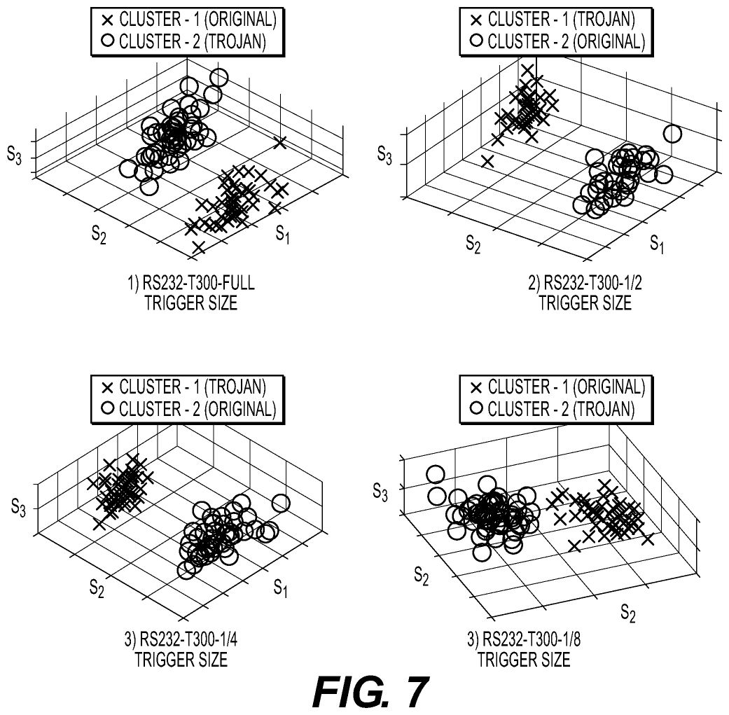

This second part of the study also investigated whether the exemplary method worked when only one HT benchmark existed in the board batch and used the same N_{C} and singular vector operation as used in the other part of the study. FIG. 7 shows the results of the clustering operation, i.e., the separation of the Trojan-free and the Trojan-affected circuits when the size of RS232-T300 circuit was varied.

In FIG. 7, it can be again observed that the system achieved 100% accuracy in terms of separating the original circuits from the Trojan-affected ones. It was also observed that as the size of the Trojan trigger decreased (e.g., to ⅛ of the original trigger size), the distance between centroids of the two classes also decreased, i.e., the cluster group of the Trojan circuit became more similar to the cluster of the original circuit as the trigger circuit is reduced.

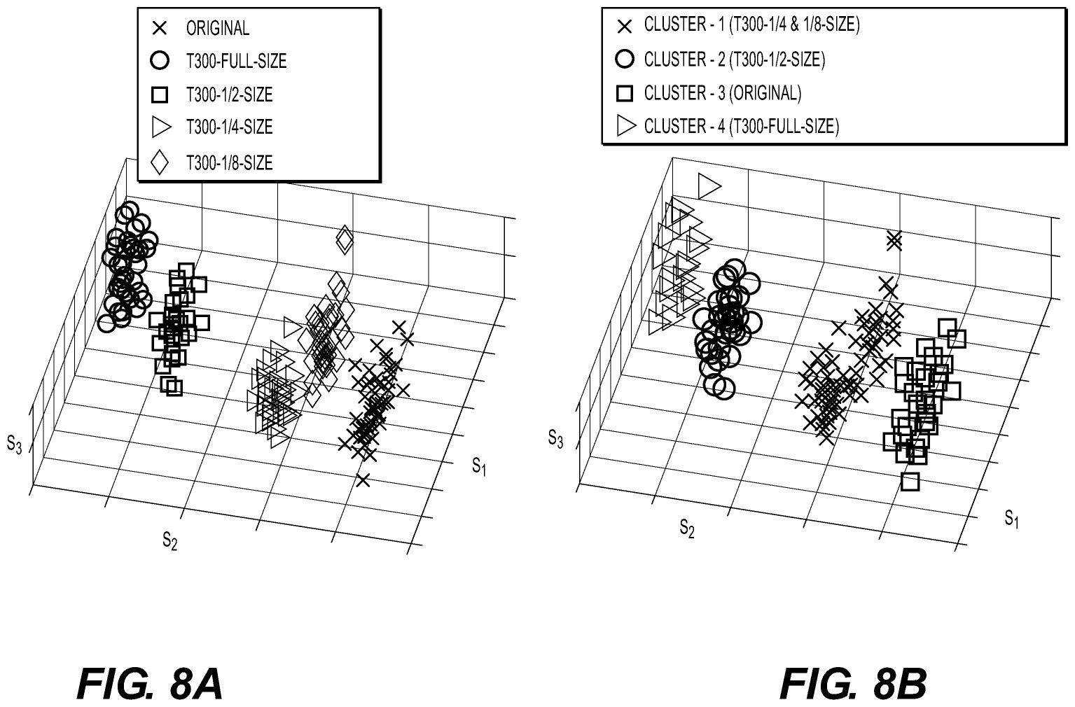

The study evaluated the trigger sizes for five different designs, one HT-free and four variants of an HT-infected design (with four different trigger sizes). FIGS. 8A and 8C show the results of the clustering separation of original and Trojan-affected circuits when the varied sizes of RS232-T300 circuit, including the original full-Trigger-size circuit, a ½-Trigger-size circuit, a ¼-Trigger-size circuit, and a ⅛-Trigger-size circuit. FIG. 8A shows the results with actual ground truths. FIG. 8B shows the results with clustering-produced labels.

From FIGS. 8A and 8B, it can be observed that the clustering operation can separate HT-free from HT-infected designs at 100% accuracy (that is, all HT-free instances are in one cluster while all HT-infected instances are in other clusters). Furthermore, the clustering operation was able to distinguish (put in separate clusters) different variants of the HT, except for the variants with ¼ and ⅛ triggers, which were in the same cluster. It is noted that the exemplary technique was able to distinguish the ⅛-trigger variant from an HT-free design, though it did not distinguish ¼—from the ⅛-trigger variant. In contrast, the HT-free design had no trigger circuit and corresponding activity and was observed to be well-separated from the HT-free design. Indeed, HTs whose circuitry and activity mimics that of the original design would be more difficult to detect, but only up to a point—even such activity-mimicking HTs would be detected if they are sufficiently large (in this particular experiment, larger than 0.19% of the original circuit).

Based on the results, the study concluded that the exemplary clustering operation and system could separate HT-free from HT-infected designs, even for very small HTs (0.19% of the original circuit, in the instant experiments). Additionally, the exemplary method can separate different HT designs from each other, except when the HTs only differ in size (but not nature) of their trigger circuitry, and that difference in size is very small (0.19% of the original circuit, in the instant experiments).

### DISCUSSION

Over the past few years, as hardware Trojan has emerged as an increasingly dangerous threat, a number of HT detection techniques using side-channel analysis have been proposed.

In [11], which is incorporated by reference herein, a method was proposed to detect hardware Trojans in the fabricated ICs by creating a backscattering side-channel. The results showed that the method could detect dormant hardware Trojans with 100% accuracy and 0% false positives. However, similar to the majority of other side-channel techniques, the approach required having a verified HT-free chip. In [8], a method was presented using EM to detect HTs without having a golden circuit by modeling the benchmark circuits they used for testing. They simulated the models to generate EM traces for the circuit and compared them with the measured ones to detect HTs with no HT-free chip. However, in [8], the technique was tested on a single FPGA board; thus, the hardware manufacturing variations were not verified. Furthermore, the technique was evaluated with activated hardware Trojans, which is also not practical for screening operation because it is extremely difficult to activate HTs without prior knowledge of their circuitry and activation mechanisms. In addition, the technique required some prior knowledge of the chip circuitry and heavily depended on the accuracy of the model and the simulator that generated the reference signals, which may not work for other circuits that are not modeled.

As machine learning has become prevalent over the last decade, a number of approaches exploited clustering techniques for HT detection. In [42], the support vector machine (SVM) and K-means clustering approach were evaluated to provide automatic layout identification in their reverse engineering-based detection method. The technique does not rely on a golden sample; however, because the nature of reverse engineering is extremely costly and time-consuming, it was not practical to build a large set of golden sample data for clustering. The methods in [43], [44] proposed a low overhead clustering-based detection technique for runtime Trojan detection. However, the methods needed golden samples for training and are only capable of detecting activated HTs. In [45], a technique was proposed using the AdaBoost Meta-Learner algorithm based on automatic feature selection using Haar-like functions to assist in reverse engineering detection. However, the method also required having golden samples.

Only a few clustering techniques can eliminate the need for golden samples [21]-[23]. However, all of these methods were pre-silicon approaches, which means that they cannot detect HTs inserted in the fabrication stage.

A post-silicon clustering technique using side-channel analysis has been proposed in [24], but the work only tested the method on a set of two FPGA, which does not give enough statistics to evaluate manufacturing variations among different hardware instances. In addition, a challenge of the side-channel technique using external measurement is that the variation across different hardware instances may cloud the difference caused by hardware Trojans. Therefore, detection accuracy would decrease when testing across multiple hardware instances. In addition, the technique used power side-channels, which provided more limited resolution and bandwidth [11]. As a result, the technique only yielded 93.75% accuracy for HT benchmarks from Trust-hub, even when testing with only two different FPGA boards.

In contrast, the exemplary method provides a golden-chip-free method for clustering fabricated integrated circuits into groups for the deployment of reverse engineering-based hardware Trojan detection techniques to a large population of ICs. The exemplary method and system can classify the evaluated boards into clusters based on how hardware Trojans (if they existed) affect their backscattering side-channel signals. Unlike prior clustering approaches, the exemplary method and system employ the backscattering side-channel, which has been shown to work better for hardware Trojan detection than other side-channels. The exemplary method and system were evaluated in a study that validated the operation on a set of 100 boards to thoroughly evaluate manufacturing variations among different hardware instances. The approach requires no prior knowledge about the chip or Trojan circuitry to cluster ICs into groups for HT detection. The results showed that the exemplary technique could tolerate manufacturing variations among hardware instances to cluster all boards correctly for not only nine different dormant Trojan designs on three different benchmark circuits from Trust-hub but also dormant Trojan designs whose trigger size is shrunk to as small as 0.19% of the original circuit.

HT Risks and Security Concerns. Over the past few years, a significant shift in the manufacturing model and design flow of IC companies has been observed due to various factors, including time-to-market, cost reduction demands, and the increased complexity of ICs. These companies had fully adopted the “horizontal model,” in which they use IPs from third-party companies and outsource all hardware fabrication to offshore foundries. While the new design flow model allowed for the reduction in the cost, time-to-market, and fabrication errors, it raised questions on the hardware level trust, which provides the base layer of the security and trust that all software layers are depended on and built.

One of the major security concerns was how to detect malicious hardware changes, which are known as hardware Trojans (HT). A typical HT includes two parts: trigger and payload. The trigger is a circuit that constantly checks for the right conditions to activate the Trojan, and the payload is the entire malicious function that the Trojan executes when it is triggered. Typically, HTs are triggered at very rare conditions, which makes them extremely challenging to detect by traditional function verification and testing.

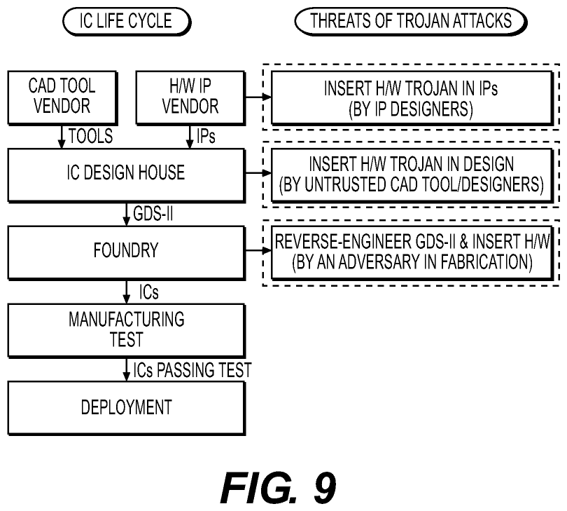

HTs could be injected into an IC by adversaries at any stage of the design and fabrication flow. FIG. 9 shows the workflow for integrated circuit fabrication and areas of risk of hardware trojan insertions. Specifically, FIG. 9 shows the IC life cycle and a subset of opportunities for inserting HTs into the IC. HT insertion at the foundry has been the most common scenario because IC companies fabricate their chips in offshore foundries, which are harder to secure. Hence, numerous HT detection techniques have been proposed to detect HT insertion at the foundry stage. These techniques can be classified into two groups: reverse engineering and side-channel approaches.

Reverse-engineering techniques relied on destructive scanning of the actual IC layout to re-build the GDSII and netlist level of the chip [1]-[7]. The destructive scanning process consisted of decapsulation to remove the die from the package, delayering to strip each layer of the die, and imaging to reconstruct images for every layer. After getting the GDSII and netlist level of the chip, these techniques were capable of detecting any malicious post-RTL-design insertion with very high accuracy by comparing them to the GDSII and netlist of a trusted design. However, reverse engineering is extremely time-consuming, expensive, and destructive because of chip demolishing after reverse engineering. Therefore, applying reverse engineering-based HT detection techniques to test a large population of ICs, although accurate and reliable, is not practical.

On the other hand, side-channel analysis-based approaches rely on measuring some non-functional properties from outside of the IC while it operates and compared the measurements to reference signals produced by either simulation [8]-[10] or by a “golden-sample” device [11]. Potential side-channels include backscattering [11], power consumption [12], [13], leakage current [14], temperature [15], electromagnetic emanations (EM) [8], [16], or a combination of multiple side-channels [17], [18]. In some techniques, additional measurement circuitry is added to the design [19], [20], which allows the specific signals to be measured close to the signal source.

However, additional circuitry results in circuit size, manufacturing cost, performance, and power overhead. Therefore, the majority of side-channel-based detection techniques require no modifications to the chip itself and rely on measuring side-channel signals outside of the chip. In contrast, to reverse engineering techniques, the side-channel-based techniques can be applied to a large population of ICs because side-channel measurements do not require damaging the board while conducting testing. However, the disadvantage of side-channel techniques is their dependence on either having a “golden” (HT-free) chip, which is not a practical assumption for foundry-inserted HTs in single-source ICs, or having a detailed simulation model, which is often impractical (complex ICs, 3rd-party IP, etc.).

To overcome these shortcomings of both types of approaches, the exemplary method uses a “golden-chip-free” clustering algorithm using a backscattering side-channel operation. This operation bridges the gap between destructive reverse engineering and traditional side-channel detection techniques. The exemplary clustering algorithm then clusters a large population of ICs based on the effect a hypothetical HT would have on the backscattering side-channel signal. In practical terms, the technique creates clusters such that the ICs in each cluster can be considered equivalent in terms of the presence or absence of an HT. This allows reverse-engineering of one IC in each cluster to be used to assess the status (in terms of HT presence and nature) of that entire cluster.

A number of techniques utilizing clustering algorithms for HT detection have been previously reported [21]-[24]; however, the majority of these methods are pre-silicon approaches, which means that they can not detect HTs inserted in the fabrication stage [21]-[23]. A post-silicon clustering technique using side-channel analysis has been proposed in [24], but authors only test their method on a set of two FPGAs, which does not give enough statistics to evaluate manufacturing variations among different hardware instances. In addition, the technique uses a power side-channel, which provides very limited resolution and bandwidth [11]. Unlike these previous approaches, the exemplary method works for HTs inserted at foundries without needing a golden chip or any prior knowledge of the chip circuitry. The study tested the exemplary technique on a set of 100 boards, which provides enough statistics for manufacturing variation, and shows that the exemplary technique outperformed other side-channels for HT detections [11].

The instant study evaluated the exemplary clustering algorithm for multiple HT and circuit benchmark designs over a set of 100 boards, in which each board was randomly loaded with either an HT-free or an HT-infected design. In all these experiments, the HT (if present) was in a dormant state, i.e., none of the HTs were activated during this evaluation. The results showed that the exemplary technique is capable of clustering all boards correctly for nine different Trojan designs on three different benchmark circuits from Trusthub [26] with 100% accuracy. In additional experiments, the study made HTs stealthier by reducing the size of their trigger, resulting in trigger circuits that are as small as 0.19% of the original circuit, and find out that the exemplary method can still correctly clusters the boards.

Hardware Trojans Characteristics and Taxonomy. Conventionally, IC hardware has been seen as the root of trust, and the only untrusted parts were assumed to be the software or firmware running on top of the hardware. However, several studies on HTs have shown that even the hardware platform cannot be trusted anymore [27]. Over the past several years, numerous papers have been published on the topic of understanding the intent and behavior [28], [25], implementation [29]-[26], and taxonomy of hardware Trojans [26]-[32]. HTs are undesired and unknown malicious modifications to a hardware circuit that have three common characteristics: rarity of activation, malicious purpose, and invasion of detection [25].

Typically, an HT includes two components: trigger and payload. The trigger circuit gets input from the host circuit to constantly check for the right conditions to activate the payload. In these very rare conditions, the payload is activated by the triggering signal from the trigger circuit to perform malicious activities. They could be leaking sensitive information, allowing the attackers to gain access to the hardware, or shortening the operational lifetime of the hardware.

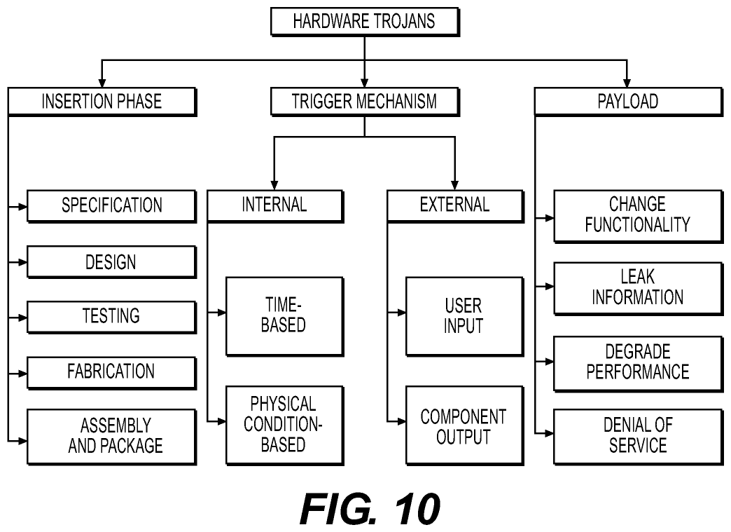

As the number and complexity of HTs increased dramatically, several studies on the topic of characterizing and classifying HTs have been published over the last few years [26]-[33]. The most comprehensive work to date is proposed by [26]. FIG. 10 illustrates the different classes of HTs. As shown in the figure, HTs can be classified by their activation mechanism, functionality, or the phase in the IC design flow they are inserted into the chip. Indeed, the different classes of hardware trojans shown in FIG. 10 can be evaluated using the clustering operation of FIG. 1.

Backscattering Side-Channels. Backscattering has been used in RFID communication systems to enable RFID tags to transmit information to RFID readers for decades [34]. A typical passive RFID tag contains an ASIC chip that can switch between two impedances, where one impedance is selected to maximize the tag's radar cross-section (RCS), while the other one is selected to minimize the RCS [11]. The RFID reader can propagate a continuous wave toward the RFID tag and measures the signal reflected back that is modulated with information about RCS changes.

Using the analogy with RFID communication systems, the authors in [11], [35] proposed using backscattering signals as a way to collect side-channels that carry information about impedance change in the circuits.

FIG. 3 (306-310) shows an example of a CMOS inverter and its equivalent impedance circuits when the output is high and low, respectively. These impedances are different because the geometry and doping levels of PMOS and NMOS are not exactly the same. As a result, similar to the mechanism of RFID tags, this impedance switching changes the circuit's RCS, thus modulates the signal that is backscattered from the circuit with the information about impedance changes in the system. This creates a back-scattering side-channel.

Unlike other analog side-channels such as electromagnetic emanation (EM) and power, which are a consequence of current-flow changes inside the chip, backscattering side-channel is an impedance-based side channel that is the consequence of impedance switching activities inside the chip. These channels can be created by propagating a continuous-wave signal toward the chip. The transistor switching activities cause changes in the chip impedance, which modifies the radar cross-section (RCS) of the circuit. This RCS change modulates the signal that is backscattered (reflected) from the chip, which creates an impedance-based backscattering side-channel. If a hardware trojan is added to a circuit, it changes the impedance of the circuit even if the Trojan is not activated. The changes will be reflected in the backscattered signal, which is beneficial to the detection of hardware Trojan.

Backscattering side-channel analysis has several benefits compared to other side-channels such as EM and power.

High bandwidth: They can provide the capability of detecting small and fast switching Trojan activities.

Signal strength not limited by leakage from devices: One characteristic that sets the backscattering side-channel aside from others is that its signal strength can be improved by increasing the carrier's input power. As a result, the backscattering side-channel can still work when there is very little leakage from devices.

Adaptable frequency: By changing the carrier frequency, the exemplary system can change the working frequency of the backscattering side-channel. This helps to increase the signal-to-noise ratio by shifting the frequency to avoid interrupts that might distract the changes caused by HT activities.

Attack Scenarios. During the fabrication process at foundries, if an adversary has access to the chip layout and adds HTs to the design, a part or the entire population of ICs will be injected HTs, depending on how the ICs are produced. As a result, there are three possible scenarios:

No adversary: There are no malicious modifications to any chip. Therefore, the entire population of ICs is HT-free.

Partial insertion: There are malicious modifications to some of the chips. This happens when different batches of ICs are fabricated at different chronological phases of production, and the attacker only inserts Trojan at one or some phases. As a result, a part of the population of ICs has Trojans, while the rest are HT-free.

Full insertion: Malicious modification exists in all of the chips. This happens when all ICs are fabricated at once, and the attacker inserts HTs into the chip layout. As a result, the entire population of ICs will be HT-infected.

The exemplary clustering method and system can be used for any of these attack scenarios.

It should be appreciated that the logical operations described above and in the appendix can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

To execute the exemplary clustering operation, a computing system can include two or more computers in communication with each other can be employed that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device to provide the functionality of a number of servers that are not directly bound to the number of computers in the computing device. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In its most basic configuration, a computing device typically includes at least one processing unit and system memory. Depending on the exact configuration and type of computing device, system memory may be volatile (such as random-access memory (RAM)), non-volatile (such as read-only memory (ROM), flash memory, etc.), or some combination of the two.

The processing unit may be a standard programmable processor that performs arithmetic and logic operations necessary for the operation of the computing device. While only one processing unit is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

The computing device may have additional features/functionality. For example, the computing device may include additional storage such as removable storage and non-removable storage including, but not limited to, magnetic or optical disks or tapes. The computing device may also contain network connection(s) that allow the device to communicate with other devices, such as over the communication pathways described herein. The network connection(s) may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The computing device may also have input device(s) such as keyboards, keypads, switches, dials, mice, track balls, touch screens, voice recognizers, card readers, paper tape readers, or other well-known input devices. Output device(s) such as printers, video monitors, liquid crystal displays (LCDs), touch screen displays, displays, speakers, etc., may also be included. The additional devices may be connected to the bus in order to facilitate the communication of data among the components of the computing device. All these devices are well known in the art and need not be discussed at length here.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is not limited to volatile media, non-volatile media, removable media, and non-removable media implemented in any method or technology for storage of information such as computer-readable instructions, data structures, program modules, or other data. System memory, removable storage, and non-removable storage are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture in order to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

Moreover, the various components may be in communication via wireless and/or hardwire or other desirable and available communication means, systems, and hardware. Moreover, various components and modules may be substituted with other modules or components that provide similar functions.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications as listed below and throughout this document are hereby incorporated by reference in their entirety herein.
[1] R. Torrance and D. James, “The state-of-the-art in is reverse engineering,” in Cryptographic Hardware and Embedded Systems-CHES 2009. Springer, 2009, pp. 363-381.
[2] A. A. Nasr and M. Z. Abdulmageed, “An efficient reverse engineering hardware trojan detector using histogram of oriented gradients,” Journal of Electronic Testing, vol. 33, no. 1, pp. 93-105, 2017.
[3] M. Fyrbiak, S. Wallat, P. Swierczynski, M. Hoffmann, S. Hoppach, M. Wilhelm, T. Weidlich, R. Tessier, and C. Paar, “Hal—the missing piece of the puzzle for hardware reverse engineering, trojan detection and insertion,” IEEE Transactions on Dependable and Secure Computing, vol. 16, no. 3, pp. 498-510, 2018.
[4] C. Bao, D. Forte, and A. Srivastava, “On reverse engineering-based hardware trojan detection,” IEEE Transactions on Computer-Aided Design of Integrated Circuits and Systems, vol. 35, no. 1, pp. 49-57, January 2016.
[5] S. Wallat, M. Fyrbiak, M. Schlogel, and C. Paar, “A look at the dark side of hardware reverse engineering—a case study,” in 2017 IEEE 2nd International Verification and Security Workshop (IVSW), July 2017, pp. 95-100.
[6] C. Bao, D. Forte, and A. Srivastava, “On application of one-class svm to reverse engineering-based hardware trojan detection,” in Fifteenth International Symposium on Quality Electronic Design, March 2014, pp. 47-54.
[7] X. Wei, Y. Diao, and Y. Wu, “To detect, locate, and mask hardware trojans in digital circuits by reverse engineering and functional eco,” in 2016 21st Asia and South Pacific Design Automation Conference (ASPDAC), January 2016, pp. 623-630.
[8] J. He, Y. Zhao, X. Guo, and Y. Jin, “Hardware trojan detection through chip-free electromagnetic side-channel statistical analysis,” IEEE Transactions on Very Large Scale Integration (VLSI) Systems, vol. 25, no. 10, pp. 2939-2948, 2017.
[9] R. Vaikuntapu, L. Bhargava, and V. Sahula, “Golden ic free methodology for hardware trojan detection using symmetric path delays,” in 2016 20th International Symposium on VLSI Design and Test (VDAT), May 2016, pp. 1-2.
[10] Y. Tang, S. Li, L. Fang, X. Hu, and J. Chen, “Golden-chip-free hardware trojan detection through quiescent thermal maps,” IEEE Transactions on Very Large Scale Integration (VLSI) Systems, pp. 1-12, 2019.
[11] L. N. Nguyen, C. Cheng, M. Prvulovic, and A. Zaji′c, “Creating a backscattering side channel to enable detection of dormant hardware trojans,” IEEE Transactions on Very Large Scale Integration (VLSI) Systems, vol. 27, no. 7, pp. 1561-1574, July 2019.
[12] D. Agrawal, S. Baktir, D. Karakoyunlu, P. Rohatgi, and B. Sunar, “Trojan detection using ic fingerprinting,” in Security and Privacy, 2007. SP′07. IEEE Symposium on. IEEE, 2007, pp. 296-310.
[13] M. Banga and M. S. Hsiao, “A region based approach for the identification of hardware trojans,” in Hardware-Oriented Security and Trust, 2008. HOST 2008. IEEE International Workshop on. IEEE, 2008, pp. 40-47.
[14] B. Hou, C. He, L. Wang, Y. En, and S. Xie, “Hardware trojan detection via current measurement: A method immune to process variation effects,” in 2014 10th International Conference on Reliability, Maintainability and Safety (ICRMS), August 2014, pp. 1039-1042.
[15] C. Bao, D. Forte, and A. Srivastava, “Temperature tracking: Toward robust run-time detection of hardware trojans,” IEEE Transactions on Computer-Aided Design of Integrated Circuits and Systems, vol. 34, no. 10, pp. 1577-1585, 2015.
[16] X. T. Ngo, Z. Najm, S. Bhasin, S. Guilley, and J.-L. Danger, “Method taking into account process dispersion to detect hardware trojan horse by side-channel analysis,” Journal of Cryptographic Engineering, vol. 6, no. 3, pp. 239-247, 2016.
[17] K. Hu, A. N. Nowroz, S. Reda, and F. Koushanfar, “High-sensitivity hardware trojan detection using multimodal characterization,” in Proceedings of the Conference on Design, Automation and Test in Europe. EDA Consortium, 2013, pp. 1271-1276.
[18] A. N. Nowroz, K. Hu, F. Koushanfar, and S. Reda, “Novel techniques for high-sensitivity hardware trojan detection using thermal and power maps,” IEEE Transactions on Computer-Aided Design of Integrated Circuits and Systems, vol. 33, no. 12, pp. 1792-1805, 2014.
19] B. Cha and S. K. Gupta, “Trojan detection via delay measurements: A new approach to select paths and vectors to maximize effectiveness and minimize cost,” in Proceedings of the conference on design, automation and test in Europe. EDA Consortium, 2013, pp. 1265-1270.
[20] M. Lecomte, J. Fournier, and P. Maurine, “An on-chip technique to detect hardware trojans and assist counterfeit identification,” IEEE Transactions on Very Large Scale Integration (VLSI) Systems, vol. 25, no. 12, pp. 3317-3330,2017.
[21] B. C akir and S. Malik, “Hardware trojan detection for gate-level ics using signal correlation based clustering,” in Proceedings of the 2015 Design, Automation & Test in Europe Conference & Exhibition. EDA Consortium, 2015, pp. 471-476.
[22] H. Salmani, “Cotd: reference-free hardware trojan detection and recovery based on controllability and observability in gate-level netlist,” IEEE Transactions on Information Forensics and Security, vol. 12, no. 2, pp. 338-350,2017.
[23] P.-S. Ba, S. Dupuis, M.-L. Flottes, G. Di Natale, and B. Rouzeyre, “Using outliers to detect stealthy hardware trojan triggering?” in Verification and Security Workshop (IVSW), IEEE International. IEEE, 2016, pp. 1-6.
[24] M. Xue, R. Bian, W. Liu, and J. Wang, “Defeating untrustworthy testing parties: A novel hybrid clustering ensemble based golden models-free hardware trojan detection method,” IEEE Access, 2018.
[25] S. Bhunia, M. S. Hsiao, M. Banga, and S. Narasimhan, “Hardware trojan attacks: threat analysis and countermeasures,” Proceedings of the IEEE, vol. 102, no. 8, pp. 1229-1247, 2014.
[26] B. Shakya, T. He, H. Salmani, D. Forte, S. Bhunia, and M. Tehranipoor, “Benchmarking of hardware trojans and maliciously affected circuits,” Journal of Hardware and Systems Security, vol. 1, no. 1, pp. 85-102,2017.
[27] M. Tehranipoor and F. Koushanfar, “A survey of hardware trojan taxonomy and detection,” IEEE design & test of computers, vol. 27, no. 1, pp. 10-25,2010.
[28] R. S. Chakraborty, S. Narasimhan, and S. Bhunia, “Hardware trojan: Threats and emerging solutions,” in High Level Design Validation and Test Workshop, 2009. HLDVT 2009. IEEE International. IEEE, 2009, pp. 166-171.
[29] J. Zhang, F. Yuan, and Q. Xu, “Detrust: Defeating hardware trust verification with stealthy implicitly-triggered hardware trojans,” in Proceedings of the 2014 ACM SIGSAC Conference on Computer and Communications Security. ACM, 2014, pp. 153-166.
[30] Z. Chen, X. Guo, R. Nagesh, A. Reddy, M. Gora, and A. Maiti, “Hardware trojan designs on basys fpga board,” Embedded system challenge contest in cyber security awareness week-CSAW, 2008.
[31] R. S. Chakraborty, I. Saha, A. Palchaudhuri, and G. K. Naik, “Hardware trojan insertion by direct modification of fpga configuration bitstream,” IEEE Design & Test, vol. 30, no. 2, pp. 45-54, 2013.
[32] R. Karri, J. Rajendran, K. Rosenfeld, and M. Tehranipoor, “Trustworthy hardware: Identifying and classifying hardware trojans,” Computer, vol. 43, no. 10, pp. 39-46, 2010. [33] X. Wang, M. Tehranipoor, and J. Plusquellic, “Detecting malicious inclusions in secure hardware: Challenges and solutions,” in Hardware-Oriented Security and Trust, 2008. HOST 2008. IEEE International Workshop on. IEEE, 2008, pp. 15-19.
[34] C. Cheng, L. N. Nguyen, M. Prvulovic, and A. Zaji′c, “Exploiting switching of transistors in digital electronics for rfid tag design,” IEEE Journal of Radio Frequency Identification, vol. 3, no. 2, pp. 67-76, June 2019.
[35] L. N. Nguyen, C. Cheng, M. Prvulovic, and A. Zaji′c, “Hardware trojan detection using backscattering side channel,” in Hardware-Oriented Security and Trust, 2019. HOST 2019. IEEE International Workshop on. IEEE, 2019.
[36] T. H. Cormen, C. E. Leiserson, R. L. Rivest, and C. Stein, Introduction to algorithms, 2009.
[37] [Online]. Available: http://www.aronia.com/products/antennas/Near-Field-Probe-Set-PBS2
[38] [Online]. Available: https://www.keysight.com/en/pdx-x201724-pn-N5183A/mxg-microwave-analog-signal-generator-100-khz-to-40-ghz?pm=spc&nid=−32490.1150253&cc=US&lc=eng
[39] [Online]. Available: https://www.keysight.com/en/pdx-x202266-pn-N9020A/mxa-signal-analyzer-10-hz-to-265-ghz?pm=spc&nid=−32508.1150426&cc=US&lc=eng
[40] [Online]. Available: https://www.terasic.com/twcgi-bin/page/archive.pl?Language=English&CategoryNo=167&No=921 &PartNo=2
[41] “Trusthub,” http://www.trust-hub.org/benchmarks/trojan.
[42] C. Bao, D. Forte, and A. Srivastava, “On reverse engineering-based hardware trojan detection,” IEEE Transactions on Computer-Aided Design of Integrated Circuits and Systems, vol. 35, no. 1, pp. 49-57, 2016.
[43] A. Kulkarni, Y. Pino, and T. Mohsenin, “Adaptive real-time trojan detection framework through machine learning,” in 2016 IEEE International Symposium on Hardware Oriented Security and Trust (HOST). IEEE,
   2016, pp. 120-123.
[44]—, “Svm-based real-time hardware trojan detection for many-core platform,” in Quality Electronic Design (ISQED), 2016 17th International Symposium on. IEEE, 2016, pp. 362-367.
[45] A. A. Nasr and M. Z. Abdulmageed, “Automatic feature selection of hardware layout: a step toward robust hardware trojan detection,” Journal of Electronic Testing, vol. 32, no. 3, pp. 357-367,2016.

1. A method to identify hidden hardware modifications in circuitries of fabricated integrated circuits, the method comprising:
wirelessly applying RF waveforms to a plurality of fabricated integrated circuits to evaluate for hidden hardware modifications;
wirelessly recording a plurality of signals of RF waveforms emanating from the plurality of fabricated integrated circuit, wherein each signal of the plurality of signals is recorded from a respective fabricated integrated circuit and is reflective of impedance characteristics of the respective fabricated integrated circuit;
generating, by a processor, a plurality of clusters of the plurality of signals based on harmonics of the plurality of signals;
adjusting, by the processor, the number of the plurality of clusters based on distances of centroids in the plurality of clusters to identify, at least, a first group of fabricated integrated circuits and a second group of fabricated integrated circuits, wherein the first group of fabricated integrated circuits has a different impedance characteristic profile to the second group of fabricated integrated circuits, wherein a difference in an impedance characteristic profile being present is indicative of a hidden hardware modification in the first group of fabricated integrated circuits or the second group of fabricated integrated circuits.

2. The method of claim 1 further comprising:
selecting at least one of the first group of fabricated integrated circuits or the second group of fabricated integrated circuits for destructive evaluation for the hidden hardware modification.

3. The method of claim 2 further comprising:
storing cluster data for the first group of fabricated integrated circuits or the second group of fabricated integrated circuits;
comparing a subsequently generated plurality of clusters associated with a second plurality of fabricated integrated circuits to the cluster data; and
rejecting the second plurality of fabricated integrated circuits associated with the subsequently generated plurality of clusters based on the comparison.

4. The method of claim 1, wherein each of the emanated RF waveforms comprises backscattering side-channel signals reflective of impedance characteristics of circuitries of the respective fabricated integrated circuit.

5. The method of claim 1, wherein the plurality of clusters are defined by a plurality of clustered elements each associated with the respective fabricated integrated circuit, and wherein each of the plurality of the clustered elements is generated by a dimensionality reduction algorithm applied to harmonics-based data of a respective recorded signal for the respective fabricated integrated circuit.

6. The method of any one of claim 5, wherein each clustered element of the plurality of clusters are generated by:
determining, by the processor, harmonic amplitudes of the given wirelessly recorded signal of the respective fabricated integrated circuit; and
determining, by the processor, a singular value decomposition value of the harmonic amplitudes.

7. The method of claim 1, wherein the plurality of clusters comprise k-mean-based cluster elements each determined based on one or more harmonic amplitudes of a respective recorded signal for the respective fabricated integrated circuit.

8. The method of claim 1, wherein the adjusting of the number of plurality of clusters based on the distances of centroids comprises:
determining if a distance among edges of cluster centroids is below a pre-defined threshold.

9. The method of claim 1, wherein the adjustment adjusting of the number of plurality of clusters based on the distances of centroids comprises:
determining if a distance among edges of cluster centroids are below a threshold determined by:
determining, by the processor, distances among centroids of the plurality of clusters;
determining, by the processor, a plurality of distances of a predefined number of nearest clusters for each cluster of the plurality of clusters;
establishing, by the processor, the threshold as a statistically derived value of the determined distances.

10. The method of claim 1, wherein the adjusting of the number of plurality of clusters based on the distances of centroids comprises:
grouping a first cluster and a second cluster of the plurality of clusters if a distance of an edge of the first cluster and an edge of the second cluster is below a threshold; and
grouping the first cluster and the second cluster if a path can be defined in a generated graph model comprising a first node associated with the first cluster and a second node associated with the second cluster.

11. The method of claim 1, wherein the harmonics of the plurality of signals comprise measured backscattering side-channel harmonics of clock signals of the respective fabricated integrated circuit.

12. The method of claim 1, wherein the hidden hardware modifications comprise one or more maliciously inserted circuitries configured to compromise operations of the fabricated integrated circuits.

13. A system comprising:
a test cell to identify hidden hardware modifications in circuitries of fabricated integrated circuits, the test cell comprising:
a first antenna assembly configured to wirelessly apply RF waveforms to a plurality of fabricated integrated circuits to evaluate for hidden hardware modifications;
a second antenna assembly configured to wirelessly receive and record a plurality of backscattering side-channel signals of the RF waveforms emanating from the plurality of fabricated integrated circuit, wherein each signal of the plurality of backscattering side-channel signals is recorded from a respective fabricated integrated circuit and is reflective of the impedance of the respective fabricated integrated circuit; and
an analysis system configured by computer-readable instructions to:
generate, by a processor, a plurality of clusters of the plurality of backscattering side-channel signals; and
adjust, by the processor, the number of the plurality of clusters based on distances of centroids of the plurality of backscattering side-channel signals in the plurality of clusters to identify, at least, a first group of fabricated integrated circuits and a second group of fabricated integrated circuits, wherein the first group of fabricated integrated circuits has a different impedance profile to the second group of fabricated integrated circuits that is indicative of a hidden hardware modification being present in the first group of fabricated integrated circuits or the second group of fabricated integrated circuits.

14. The system of claim 13, wherein the plurality of clusters are generated based on backscattering side-channel harmonics of clock signals of the respective fabricated integrated circuit.

15. The system of claim 13, wherein the analysis system is configured by computer-readable instructions to
select at least one of the first group of fabricated integrated circuits or the second group of fabricated integrated circuits for destructive evaluation for the hidden hardware modification.

16. The system of claim 15, wherein the analysis system is configured by computer-readable instructions to:
store cluster data for the first group of the second group of fabricated integrated circuits;
compare a subsequently generated plurality of clusters to the cluster data; and
reject a second plurality of fabricated integrated circuits associated with the subsequently generated plurality of clusters based on the comparison.

17. (canceled)

18. The system of claim 13, wherein the plurality of clusters are defined by a plurality of clustered elements each associated with the respective fabricated integrated circuit, and wherein each of the plurality of the clustered elements is generated by a dimensionality reduction algorithm applied to harmonics-based data of a recorded backscattering side-channel signal for the respective fabricated integrated circuit.

19.-22. (canceled)

23. The system of claim 13, wherein the instructions to adjust of the number of plurality of clusters based on distances of centroids comprises:
instructions to group a first cluster and a second cluster of the plurality of clusters if a distance of an edge of the first cluster and an edge of the second cluster is below a threshold; and
instructions to group the first cluster and the second cluster if a path can be defined in a generated graph model comprising a first node associated with the first cluster and a second node associated with the second cluster.

24. The system of claim 13 any one of claims 13-23,
wherein the harmonics of the plurality of backscattering side-channel signals comprises measured backscattering side-channel harmonics of clock signals of the respective fabricated integrated circuit.

25.-29. (canceled)

30. A non-transitory computer-readable medium having instructions stored thereon, wherein the instructions, when executed by a processor, cause the processor to:
direct a first antenna assembly to apply wireless RF waveforms to a plurality of fabricated integrated circuits to evaluate for hidden hardware modifications;
direct a second antenna assembly to wirelessly receive and record a plurality of backscattering side-channel signals of the RF waveforms emanating from the plurality of fabricated integrated circuit, wherein each signal of the plurality of backscattering side-channel signals is recorded from a respective fabricated integrated circuit and is reflective of the impedance of the respective fabricated integrated circuit;
receive, by a processor, the recorded plurality of backscattering side-channel signal;
generate, by the processor, a plurality of clusters of the plurality of backscattering side-channel signals; and
adjust, by the processor, the number of the plurality of clusters based on distances of centroids of the plurality of backscattering side-channel signals in the plurality of clusters to identify, at least, a first group of fabricated integrated circuits and a second group of fabricated integrated circuits, wherein the first group of fabricated integrated circuits has a different impedance profile to the second group of fabricated integrated circuits that is indicative of a hidden hardware modification being present in the first group of fabricated integrated circuits or the second group of fabricated integrated circuits.
